(19) United States
(12) Patent Application Publication
(10) Pub. No.: US 2024/0206485 A1
(43) Pub. Date: Jun. 27, 2024

(54) PASS-THROUGH SYSTEM FOR TREATMENT AND/OR COOLING OF PERISHABLE PRODUCTS AND METHODS OF USE THEREOF

(71) Applicant: RLMB GROUP, LLC, Honolulu, HI (US)

(72) Inventors: Randall Craig BOWDEN, Honolulu, HI (US); Robert W. HERDEMAN, Loveland, OH (US)

(21) Appl. No.: 18/394,276

(22) Filed: Dec. 22, 2023

Related U.S. Application Data
(60) Provisional application No. 63/434,719, filed on Dec. 22, 2022.

(51) Int. Cl. A23B 7/055; A23B 7/04; A23B 7/08; A23B 7/10; A23B 7/144; A23L 3/00; A23L 3/3409

(52) U.S. Cl. CPC A23B 7/055; A23B 7/0416; A23B 7/08; A23B 7/10; A23B 7/144; A23L 3/001; A23L 3/003; A23L 3/34095; A23V 2200/04; A23V 2200/10; A23V 2200/14; A23V 2200/15; A23V 2200/212; A23V 2200/22; A23V 2200/23; A23V 2200/25; A23V 2250/022; A23V 2250/08; A23V 2250/116; A23V 2250/128; A23V 2250/132; A23V 2250/152

(57) ABSTRACT

A pass-through system and method for treating and/or pre-cooling perishable products uses a conveyor system with a treatment chamber that is configured to be contained (or closed) to provide a sealed environment and enhanced with forced air flow to recirculate air and/or functional substances including, e.g., sanitizers, as well as ripening management and conditioning agents, across the surface of perishable products. The enhanced forced air is an integral part of the system for efficient treatment and can also be cooled to accomplish rapid cooling.

### CROSS REFERENCE TO RELATED APPLICATIONS

This application claims priority to U.S. Provisional Patent Application No. 63/434,719, filed Dec. 22, 2022, which is hereby incorporated herein by reference in its entirety.

### TECHNICAL FIELD

The present invention relates to a pass-through system and method for treating, precooling, and/or handling perishable products. Functional treatments, like sanitizing substances, are recirculated through pallets that move through the pass-through system and across the surface of the perishable product. The recirculating air may be cooled to precool the perishable product.

### BACKGROUND

Generally, perishable product is routinely harvested and processed in ways that do not always yield exceptional quality, condition or ripeness, and shelf life due to multiple root causes that originate with the technology available and practiced by the grower/shipper. Perishable product that is packed in the field and/or a greenhouse in the final consumer package or market ready case is not cleaned, washed, or sanitized to reduce spoilage or pathogenic organisms that may be present on the surface. Additionally, typical produce cooling and distribution facilities operate seasonally during the climate driven growing and harvest seasons. These regional facilities are located within hours of the various harvest locations. The facility/warehouse operations that are performing the precooling most often do not have rigorous cleaning and sanitization during the seasonal operation. As harvested products are brought into the cooling facility from the fields some of these products bring with them mold and micro-organisms contamination, and the contamination levels generally increase through the harvest season. Air is circulated throughout the cooling facility/warehouse and also forced across the perishables for precooling. Mold and other micro-organisms can accumulate in this air and on the warehouse and/or cooling equipment/process surfaces. This results in further contamination of the perishable product from airborne mold and spoilage organisms pushed through pallets during precooling.

There, thus, remains a need to introduce sanitation as a primary treatment into the handling process for fresh perishable products. While sanitizing the perishable, other treatments that are not feasible with current operations and processes can be included to deliver additional quality and shelf-life benefits. The addition of cooling within this “clean” process would further enhance the quality benefits. Importantly, the treatment process must be accomplished within the production capacity or speed parameters of the operation. As well as provide reduced harvest to cool time, clean air and, if necessary, cooling air, containing sanitizer for reduced surface mold, spoilage, and pathogenic organisms, while also having the ability to rapidly achieve intended product temperature, if desired.

### BRIEF SUMMARY OF THE INVENTION

According to one embodiment, the present invention provides a mobile, modular pass-through system for treating and/or cooling a perishable product to its intended condition. The system comprises (a) at least one plenum, (b) at least one axial fan attached to the at least one plenum, the at least one axial fan configured to recirculate forced air through one or more pallets of perishable product and across perishable products contained on the one or more pallets of perishable product, (c) one or more sealing mechanisms configured to contain and channel the forced air being recirculated between the at least one plenum and through the one or more pallets of perishable product and across the perishable products contained on the one or more pallets of perishable product, (d) at least one treatment delivery mechanism (device or apparatus), (e) one or more conveyors configured to move the one or more pallets of perishable product through the pass-through system, and (f) a treatment chamber configured to provide a sealed environment (i.e., is contained or closed) for treating and/or cooling the perishable product.

According to an embodiment, the one or more sealing mechanism comprise (i) at least one vertical sealing device and (ii) at least one horizontal sealing device. According to another embodiment, the one or more sealing mechanism comprise (i) two vertical sealing devices and (ii) two horizontal sealing devices.

According to an embodiment, the forced air is cooled.

According to an embodiment, the pass-through system can be located at seasonal or temporary operations.

According to an embodiment, the one or more pallets of perishable product includes at least one of (i) a secured top sheet or top cap, (ii) a bottom sheet or cap, or (iii) a combination of (i) and (ii), to contain and/or channel forced air being recirculated through the one or more pallets of perishable product and across the perishable products contained on the one or more pallets of perishable product via the at least one axial fan.

According to an embodiment, the at least one treatment delivery device is configured to provide a small micron, gaseous, vaporized, and/or atomized functional substance treatment to the perishable products contained on the one or more pallets of perishable product via recirculated air. According to another embodiment, the substance treatment does not saturate the perishable product with excess moisture. According to another embodiment, the perishable product is within containers having vents on one or more sides in order for the perishable product to be treated with the substance treatment provided by the at least one treatment delivery mechanism, by allowing airflow to contact the perishable product. According to another embodiment, the perishable product is within containers having two or more vents and/or an uncovered open top in order for the perishable product to be treated with the substance treatment provided by the at least one treatment delivery mechanism, by allowing airflow to contact the perishable product.

According to an embodiment, the at least one treatment delivery device is configured to provide substance treatments that include one or more of hydration, sanitizing, conditioning, neutralization of fungicide/pesticide/herbicide chemicals on a surface of the perishable product, and other protective, preservative, and functional substances or treatments. According to another embodiment, the substance treatments include one or more of (i) sanitizers/oxidizers such as ozone, hydrogen peroxide, ionized hydrogen peroxide, peracetic acid, ionized water, acidified water, alkaline water, sulfur dioxide, chlorine compounds and derivatives, (ii) ethylene, (iii) 1-MCP, (iv) water/humidity, or (v) combinations thereof. According to another embodiment, the substance treatment is (i) selected from the group consisting of a sanitizer, an antifungal, an essential oil, a reducing agent, a surfactant, a humectant, a photosensitizer, a buffering agent, a mineral salt, an aroma, a sweetener or flavoring agent, a sealing or coating substance, an anti-browning substance, an ethylene scavenger, ethylene blocking compound, a ripening agent, a nutritional substance, a probiotic, a coloring, nano particles, phages, enzymes, sugar substance, an absorbent, a neutralizing agent, and an oxidizing agent, or (ii) selected from the group consisting of chlorine dioxide, hydrogen peroxide, peracetic acid, ozone, ionized water, ethephon, ethrel, lauryl alcohol, lemon oil, orange oil, grapefruit oil, rosemary oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, calcium phosphate, esters, linear terpenes, cyclic terpenes, alcohols, aldehydes, esters, ketones, lactones, thiols, rose oil, rose essence, air, and fruit essence.

According to an embodiment, the treatment chamber is configured to treat the perishable product (i) before the perishable product is cooled, (ii) while the perishable product is being cooled, or (iii) after the perishable product is cooled.

According to an embodiment, the treatment chamber is configured to treat the perishable product without applying heat (i.e., non-thermally).

According to an embodiment, the perishable product includes one or more of (i) pre-packed product after harvesting, (ii) bulk packed product into a harvest container to supply to a packing line, and (iii) product packed into a partial container that needs additional handling/processing steps to complete the packing of the harvested product.

According to an embodiment, the one or more conveyors are configured to move the pallets quickly into and out of the treatment chamber (e.g., a containment treatment chamber) and hold them in place, move them at a deliberate rate through, or pause for a specified treatment dwell time within individual treatment zones of the treatment chamber or the treatment chamber (e.g., a containment treatment chamber) of the pass-through system. According to another embodiment, the one or more conveyors pause the one or more pallets for (i) a treatment dwell time of less than one minute to treat the perishable product within individual treatment zones of the treatment chamber or the treatment chamber of the pass-through system, and/or (ii) a cooling dwell time of at least one hour to cool the perishable product within individual treatment zones of the treatment chamber or the treatment chamber of the pass-through system. According to an embodiment, each of the individual treatment zones within the treatment chamber or the entire treatment chamber is configured and programmed to deliver a product specific treatment and/or a defined substance treatment with a defined dwell time, wherein the one or more conveyors pause the one or more pallets to achieve the product specific treatment and/or the defined substance treatment for the defined dwell time within the individual treatment zones within the treatment chamber or the entire treatment chamber of the pass-through system.

According to another embodiment, the one or more conveyors are configured to move the pallets into and out of the treatment chamber (e.g., a containment treatment chamber) and hold the one or more pallets in place for a specified treatment dwell time within individual treatment zones of the treatment chamber or the treatment chamber (e.g., a containment treatment chamber) of the pass-through system, wherein the one or more conveyors reverse direction so treated pallets exit the treatment chamber. According to another embodiment, the one or more conveyors hold the one or more pallets in place for (i) a treatment dwell time of less than one minute to treat the perishable product within individual treatment zones of the treatment chamber or the treatment chamber of the pass-through system, and/or (ii) a cooling dwell time of at least one hour to cool the perishable product within individual treatment zones of the treatment chamber or the treatment chamber of the pass-through system. According to an embodiment, the one or more conveyors hold the one or more pallets in place for (i) a short duration treatment dwell time of less than one minute to treat the perishable product within individual treatment zones of the treatment chamber or the treatment chamber of the pass-through system, (ii) a medium duration treatment dwell time of one minute to 15 minutes to treat the perishable product within individual treatment zones of the treatment chamber or the treatment chamber of the pass-through system, and/or (iii) a prolonged duration treatment dwell time when adding one or more cooling chambers of from 15 minutes to 120 minutes to treat the perishable product within individual treatment zones of the treatment chamber or the treatment chamber of the pass-through system.

According to an embodiment, the one or more sealing mechanisms engage with the one or more pallets of perishable product to create a seal around contact points on the one or more pallets and the at least one plenum for channeling the forced air being recirculated through the one or more pallets of perishable product and across the perishable products contained on the one or more pallets of perishable product during treatment.

According to an embodiment, the one or more sealing mechanisms include at least one of pressure rollers, arc loop baffles, wing baffles, angled baffles, belts, louvers, shutters, ducting, plastic, fabric, or metal guides, or similar devices for channeling and containing air flow. According to another embodiment, the one or more sealing mechanisms include combinations of air dependent, spring-loaded, and other devices that are mechanically controlled and activated. According to an embodiment, the one or more sealing mechanisms achieve a seal when the at least one axial fan operates in either a forced air or suction air flow. According to another embodiment, the one or more sealing mechanisms permit movement of the pallets during operation either by releasing if air flow is stopped or mechanical components pull the material back, or rotate, roll with, or are directionally aligned with the movement of the pallets while air is still flowing.

According to an embodiment, the pass-through system has transition zones that are present just before and just after treatment zones of the treatment chamber (e.g., a containment treatment chamber) where pallets can collect and stage before entry and after exit to provide containment of any treatment substances from exiting the pass-through system. According to another embodiment, the transition zones use one or more of rollup, side swing, or sliding doors to quickly open and close for pallet movement and substance containment.

According to an embodiment, the pass-through system comprises a modified shipping container, a semi-trailer, a prefabricated room, or one or more fabricated chambers/modules.

According to an embodiment, the system further comprises one or more sensors configured to measure the conditions within the treatment chamber (e.g., a containment treatment chamber), including the properties of any treatment substances. According to another embodiment, the system further comprises one or more sensors configured to measure the conditions within the transition zones and/or the treatment chamber (e.g., a containment treatment chamber), including the properties of any treatment substances. According to another embodiment, the system further comprises a control system configured to control the treating and/or cooling of the perishable product based on the conditions measured by the one or more sensors.

According to an embodiment, the perishable product includes one or more types of perishable product in the one or more pallets of perishable product. According to another embodiment, the system further comprises one or more sensors configured to identify the one or more types of perishable product in the one or more pallets of perishable product to thereby control the treating and/or cooling of the perishable product. According to another embodiment, the system further comprises a control system configured to control the treating and/or cooling of the perishable product based on the one or more types of perishable product identified by the one or more sensors. According to yet another embodiment, the control system is configured to control the treating and/or cooling of the perishable product based on machine learning related to treating and/or cooling of a previously-treated perishable product based on a type of the previously-treated perishable product.

According to an embodiment, the at least one axial fan is configured (i) to apply forced air pressure to distribute substance treatment through the pallets, and (ii) to create air flow that is reversible to either force air through the pallet or suck air back through it. According to another embodiment, the one or more pallets of perishable product includes at least one of (i) a top sheet or top cap, (ii) a bottom sheet or cap, or (iii) a combination of (i) and (ii), to contain and/or channel the air flow being created by the at least one axial fan.

According to an embodiment, the system further comprises cooling coils and related refrigeration equipment to reduce the temperature of the perishable product.

According to an embodiment, the perishable product is treated with sanitizing substances that include at least one of ozone, hydrogen peroxide, ionized hydrogen peroxide, ozonated water, ionized water, peracetic acid, sodium hypochlorite, ionized chlorinated water, electrochlorinated water, oxidizing materials, and any other form(s) (including ionized and oxidized forms) of these substances. According to one embodiment, the sanitizing substances are mixed with a carrier that includes one of air, industrial gas, water, or alcohol.

According to an embodiment, sanitizing substances are added to recirculating air continually, intermittently, in stages, steps, cycles, or pulses.

According to an embodiment, the perishable product includes one or more of tomatoes, berries, cherries, meat products, fresh cut flowers, cannabis products, hemp products, or other fruits and vegetables. According to an embodiment, the perishable product includes one or more of tomatoes, berries, cherries, fresh cut flowers, cannabis products, hemp products, or other fruits and vegetables.

According to an embodiment, the system further comprises multiple contained treatment zones in which one or more different treatments can be applied to accomplish multiple benefits and/or enhancements to the perishable product.

According to an embodiment, components of the system comprise specialized materials of construction that are used to protect the surfaces and mechanical components from the damaging effects of any oxidizers and sanitizers used.

According to another embodiment, the present invention provides a method for treating and/or cooling a perishable product to its intended condition using a mobile, modular pass-through system. The method includes providing a pass-through system that includes (a) at least one plenum, (b) at least one axial fan attached to the at least plenum, the at least one axial fan configured to recirculate forced air through one or more pallets of perishable product and across perishable products contained on the one or more pallets of perishable product, (c) at least one treatment delivery mechanism (device or apparatus), (d) one or more conveyors configured to move the one or more pallets of perishable product through the pass-through system, and (d) a treatment chamber configured to provide a sealed environment (i.e., is contained or closed) for treating and/or cooling the perishable product. The method further includes moving the one or more pallets of perishable product through the pass-through system and into the treatment chamber using the one or more conveyors, and treating or cooling the perishable product in the treatment chamber (e.g., a containment treatment chamber).

According to an embodiment, the one or more pallets of perishable product includes at least one of (i) a top sheet or top cap, (ii) a bottom sheet or cap, or (iii) a combination of (i) and (ii), to contain and/or channel the forced air being recirculated through the one or more pallets of perishable product and across the perishable products contained on the one or more pallets of perishable product via the at least one axial fan.

According to an embodiment, treating the perishable product in the treatment chamber (e.g., a containment treatment chamber) comprises applying substance treatments that include one or more of hydration, sanitizing, conditioning, neutralization of fungicide/pesticide/herbicide chemicals on the surface, and other protective, preservative, and functional substances or treatments.

According to an embodiment, the substance treatments include one or more of (i) sanitizers/oxidizers such as ozone, hydrogen peroxide, ionized hydrogen peroxide, peracetic acid, ionized water, acidified water, alkaline water, sulfur dioxide, chlorine compounds and derivatives, (ii) ethylene, (iii) 1-MCP, (iv) ethephon, (v) ethrel, (vi) lauryl alcohol, (vii) water/humidity, or (viii) combinations thereof.

According to an embodiment, the method further comprises applying and recirculating one or more of forced air, humidity, and dispersed substance treatments across the perishable product to impart minimal free moisture or undesirable or unintended chemical residue on the surface of the perishable product. According to another embodiment, the one or more pallets of perishable product includes at least one of (i) a top sheet or top cap, (ii) a bottom sheet or cap, or (iii) a combination of (i) and (ii), to contain and/or channel forced air being applied and recirculated across the perishable product.

According to an embodiment, treating the perishable product in a treatment zone, a treatment module, or the treatment chamber (e.g., a containment treatment chamber) includes cooling of the perishable product. According to an embodiment, the treating of the perishable product occurs (i) before the cooling of the perishable product, (ii) during the cooling of the perishable product, or (iii) after the cooling of the perishable product.

According to an embodiment, treating the perishable product in the treatment chamber is conducted without applying heat (i.e., non-thermally).

According to an embodiment, treating the perishable product in the treatment chamber (e.g., a containment treatment chamber) comprises a batch treatment, a semi-automatic batch treatment, a hybrid pass-through with programmed pause during treatments, or a pass-through with continuous treatment.

According to an embodiment, treating the perishable product in the treatment chamber (e.g., a containment treatment chamber) comprises a treatment that is programmed to provide a concentration or delivery amount of active substance to the surface of the perishable product within a controlled dwell or contact time within the treatment chamber (e.g., a containment treatment chamber).

According to an embodiment, the perishable product includes one or more of tomatoes, berries, cherries, meat products, fresh cut flowers, cannabis products, hemp products, or other fruits and vegetables. According to an embodiment, the perishable product includes one or more of tomatoes, berries, cherries, fresh cut flowers, cannabis products, hemp products, or other fruits and vegetables.

According to an embodiment, the substance treatment is (i) selected from the group consisting of a sanitizer, an antifungal, an essential oil, a reducing agent, a surfactant, a humectant, a photosensitizer, a buffering agent, a mineral salt, an aroma, a sweetener or flavoring agent, a sealing or coating substance, an anti-browning substance, an ethylene scavenger, ethylene blocking compound, a ripening agent, a nutritional substance, a probiotic, a coloring, nano particles, phages, enzymes, sugar substance, an absorbent, a neutralizing agent, and an oxidizing agent, or (ii) selected from the group consisting of chlorine dioxide, hydrogen peroxide, peracetic acid, ozone, ionized water, ethephon, ethrel, lauryl alcohol, lemon oil, orange oil, grapefruit oil, rosemary oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, calcium phosphate, esters, linear terpenes, cyclic terpenes, alcohols, aldehydes, esters, ketones, lactones, thiols, rose oil, rose essence, air, and fruit essence.

According to an embodiment, the substance treatment cleans the perishable product (including, e.g., washing the perishable product with a minimal amount of water or a liquid (i.e., dry washing or cleaning)), prevents moisture loss of the perishable product, slows senescence of the perishable product, is a preservative, is comprised of ionized water or ionized air, enhances color, enhances flavor, enhances aroma, enhances texture of the perishable product, acts as a pH buffer, breaks down biofilm on the surface, or combinations thereof.

According to an embodiment, the substance treatment is a first substance, and the method further comprises directly applying a second substance which is different than the first substance to the surface of the perishable product at synchronous or asynchronous points during the treating of the perishable product using a second carrier, wherein the second substance enhances the efficacy of the first substance.

According to an embodiment, the method further comprises measuring the conditions within the treatment chamber (e.g., a containment treatment chamber) using one or more sensors to thereby measure the properties of any treatment substances. According to another embodiment, the method further comprises measuring the conditions within one or more transition zones and/or the treatment chamber (e.g., a containment treatment chamber) using one or more sensors to thereby measure the properties of any treatment substances. According to another embodiment, the method further comprises controlling the treating or cooling of the perishable product in the treatment chamber using a control system, based on the conditions measured by the one or more sensors.

According to an embodiment, the perishable product includes one or more types of perishable product in the one or more pallets of perishable product. According to another embodiment, the method further comprises identifying the one or more types of perishable product in the one or more pallets of perishable product using one or more sensors to thereby control the treating or cooling of the perishable product. According to another embodiment, the method further comprises controlling the treating or cooling of the perishable product in the treatment chamber using a control system, based on the one or more types of perishable product identified by the one or more sensors. According to yet another embodiment, the control system is configured to control the treating or cooling of the perishable product based on machine learning related to treating and/or cooling of a previously-treated perishable product based on a type of the previously-treated perishable product.

According to one embodiment, the present invention provides a system to treat perishable products comprising integrated apparatuses and methods to achieve and maintain post-harvest objectives of safety, freshness, condition, and low surface microbial spoilage activity efficiently and effectively.

According to an embodiment, a programmed treatment protocol is determined for each perishable product and the apparatus and methods execute the programmed treatment protocol in a commercial setting. According to another embodiment, the programmed treatment protocol is determined based on conditions measured within the system using one or more sensors. According to an embodiment, the conditions measured within the system include measured properties of any treatment substances. According to another embodiment, the programmed treatment protocol is controlled by a control system included within the system, wherein the control system is configured to control the programmed treatment protocol based on the conditions measured by the one or more sensors.

According to an embodiment, a programmed treatment protocol is determined for each perishable product based on one or more of (i) historical data, (ii) published data, (iii) empirical data, (iv) input from sensors, or (iv) combinations thereof, in order to adjust a product specific treatment that includes a level of treatment applied, dwell time, etc.

According to an embodiment, the perishable products include one or more types of perishable products. According to another embodiment, a programmed treatment protocol is determined based on the one or more types of perishable products identified by one or more sensors included within the system. According to another embodiment, the programmed treatment protocol is controlled by a control system included within the system, wherein the control system is configured to control the programmed treatment protocol based on the one or more types of perishable products identified by the one or more sensors. According to yet another embodiment, the control system is configured to control the programmed treatment protocol based on machine learning related to treating a previously-treated perishable product.

According to an embodiment, treatment modules and methods can be combined with other treatment modules, chambers, or zones in parallel or in sequence to enable multi-functional treatments. According to an embodiment, the treatment chamber(s) include a cooling zone and a treatment zone. According to another embodiment, the treatment zone is configured to treat the perishable products (i) before the perishable products are cooled, (ii) while the perishable products are being cooled, or (iii) after the perishable products are cooled. According to an embodiment, the treatment modules are configured to treat the perishable products without applying heat (i.e., non-thermally).

According to an embodiment, the overall system and operational programing can be adjusted to: (i) deliver prescribed product treatment and/or cooling; (ii) accommodate different palletized products and pallet dimensions; (iii) match preferred workflow requirements, steps, and sequencing; (iv) start and stop to meet variable production timing and volumes; (v) deliver optimal and directional airflow for fast, low cost, effective treatments and cooling; (vi) efficiently reach target core cooling temperature across the entire pallet or product; and/or (vii) provide isolation-containment and/or deactivation of treatments as appropriate.

Additional features, advantages, and embodiments of the invention are set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1A is a diagram illustrating a plenum having a pair of axial fans for delivering forced air through the plenum according to an embodiment of the invention.

FIG. 1B is a diagram illustrating a portion of a pass-through system for providing forced air to multiple pallets of perishable product according to an embodiment of the invention.

FIG. 2 is a diagram illustrating a pass-through system for providing forced air to multiple pallets of perishable product according to an embodiment of the invention.

FIGS. 3A to 3C are illustrations of arc-wing baffles for sealing areas of a pass-through system according to an embodiment of the invention, with FIG. 3C illustrating a top view of an arc-wing baffle according to an embodiment of the invention.

FIG. 4A is a diagram illustrating a top view of a portion of a pass-through system for providing forced air to multiple pallets of perishable product according to an embodiment of the invention.

FIGS. 4B and 4C illustrate an arc-wing baffle for sealing areas of the pass-through system shown in FIG. 4A according to an embodiment of the invention.

FIG. 5A is a diagram illustrating an end view of the portion of the pass-through system of FIG. 4A for providing forced air to multiple pallets of perishable product according to an embodiment of the invention.

FIGS. 5B and 5C illustrate an arc-wing baffle for sealing areas of the pass-through system shown in FIG. 5A according to an embodiment of the invention.

FIG. 6A is a diagram illustrating a top view of a portion of a pass-through system for providing suction air flow to multiple pallets of perishable product according to an embodiment of the invention.

FIGS. 6B and 6C illustrate an arc-wing baffle for sealing areas of the pass-through system shown in FIG. 6A according to an embodiment of the invention.

FIG. 7A is a diagram illustrating an end view of the portion of the pass-through system of FIG. 6A for providing suction air flow to multiple pallets of perishable product according to an embodiment of the invention.

FIGS. 7B and 7C illustrate an arc-wing baffle for sealing areas of the pass-through system shown in FIG. 7A according to an embodiment of the invention.

FIG. 8 is a diagram illustrating a top view of a portion of a pass-through system for providing suction air flow to multiple pallets of perishable product according to an embodiment of the invention.

FIG. 9A is a diagram illustrating a top view of spring-loaded arc-wing baffles for sealing multiple pallets of perishable product in a pass-through system according to an embodiment of the invention.

FIG. 9B illustrates a spring-loaded arc-wing baffle for sealing areas of the pass-through system shown in FIG. 9A according to an embodiment of the invention.

FIG. 10A is a diagram illustrating a pass-through system having a top sealing system for providing forced air to multiple pallets of perishable product according to an embodiment of the invention.

FIG. 10B is an exploded, partial front view of a portion of the pass-through system shown in FIG. 10A according to an embodiment of the invention.

FIG. 11A is a diagram illustrating a pass-through system having a front and back sealing system for providing forced air to multiple pallets of perishable product according to an embodiment of the invention.

FIG. 11B is an exploded, partial side view of a portion of the pass-through system shown in FIG. 11A according to an embodiment of the invention.

FIG. 11C is a diagram illustrating the pass-through system of FIG. 11A in which the multiple pallets of perishable product are sealed for treatment according to an embodiment of the invention.

FIG. 12A is a diagram illustrating a top view of a pass-through system having extra containment doors and modules for providing forced air to multiple pallets of perishable product according to an embodiment of the invention.

FIG. 12B is a diagram illustrating a side view of the pass-through system shown in FIG. 12A.

FIG. 13A illustrates another diagram of a top view of the pass-through system having extra containment doors and modules of FIG. 12A.

FIG. 13B is a diagram illustrating a side view of the pass-through system shown in FIG. 13A.

FIG. 14A is a diagram illustrating a top view of a pass-through system having extra swing seal doors and containment zones/modules for providing forced air to multiple pallets of perishable product according to an embodiment of the invention.

FIG. 14B is a diagram illustrating a side view of the pass-through system shown in FIG. 14A.

FIG. 15A is a diagram illustrating a top view of a pass-through system having swing seal doors and no containment zones/modules for providing forced air to multiple pallets of perishable product according to an embodiment of the invention.

FIG. 15B is a diagram illustrating a side view of the pass-through system shown in FIG. 15A.

FIG. 16A illustrates a side isometric view of a portion of a pass-through system for providing forced air to a pallet of perishable product according to an embodiment of the invention.

FIG. 16B illustrates a top isometric view of an opposite side of the portion of the pass-through system of FIG. 16A.

FIG. 17 is a diagram of a side view of the portion of the pass-through system of FIG. 16A.

FIG. 18 is a schematic right side view of a portion of the pass-through system of FIG. 16A.

FIG. 19 is a schematic left side view of a portion of the pass-through system of FIG. 16A.

FIG. 20 is a schematic top view of a portion of the pass-through system of FIG. 16A.

FIG. 21 is another schematic top view of a portion of the pass-through system of FIG. 16A.

FIG. 22 is a schematic front view of a portion of the pass-through system of FIG. 16A.

FIG. 23A is another schematic front view of a portion of the pass-through system of FIG. 16A.

FIG. 23B is an exploded, partial schematic view of a portion of the pass-through system shown in FIG. 23A according to an embodiment of the invention.

FIG. 23C is an exploded, partial schematic view of a portion of the pass-through system shown in FIG. 23A according to an embodiment of the invention.

FIG. 24 is a schematic front view of a portion of the pass-through system of FIG. 16A in which functional treatments and/or cooling air are being circulated through the system.

FIG. 25 is an illustration of a front, isometric view of a portion of a pass-through system for providing forced air to a pallet of perishable product according to an embodiment of the invention.

FIG. 26 is an illustration of a left side view of the portion of the pass-through system of FIG. 25.

FIG. 27 is an illustration of a rear, isometric view of the portion of the pass-through system of FIG. 25.

FIG. 28 is an illustration of a right side view of the portion of the pass-through system of FIG. 25.

FIGS. 29A and 29B are diagrams illustrating the various functional operations and systems for performing the cooling, sanitization, and/or functional treatment steps according to an embodiment of the invention.

FIG. 30 is a diagram illustrating an embodiment of a system having a functional treatment and delivery platform for providing functional treatment substances (e.g., sanitization substances) to a perishable product after harvesting.

FIG. 31A illustrates a schematic of a pallet of perishable products including a top cap and a bottom cap, according to an embodiment of the invention.

FIG. 31B illustrates a schematic of a pallet of perishable products including a top cap, a bottom cap, and a side wrap to form a sealed enclosure around the perishable products on the pallet, according to an embodiment of the invention.

FIG. 32A is an illustration of an end view of a single zone of a multi-zone pass-through system having a pallet of perishable product on a conveyor according to an embodiment of the invention.

FIG. 32B is an illustration of an inside view of the single zone of the multi-zone pass-through system of FIG. 32A showing recirculating airflow for treatments and/or cooling of the pallet of perishable product according to an embodiment of the invention.

FIG. 33A is an illustration of an isometric view of a single zone of a multi-zone pass-through system that includes a plenum and vertical and horizontal sealing devices with a pallet of perishable product entering the pass-through system according to an embodiment of the invention.

FIG. 33B is an illustration of an isometric view of the single zone of the multi-zone pass-through system of FIG. 33A showing the suction side of the plenum according to an embodiment of the invention.

FIG. 34A is an illustration of a partial, top view of a single zone of a multi-zone pass-through system having a plenum, an axial fan, and spring loaded loop baffles according to an embodiment of the invention.

FIG. 34B is an exploded, partial view of the top view of the single zone of the multi-zone pass-through system shown in FIG. 34A according to an embodiment of the invention.

FIG. 35 is an illustration of a top view of a pallet entrance and exit of a single zone of a multi-zone pass-through system having a plenum, an axial fan, and sealing devices according to an embodiment of the invention.

FIG. 36 is an illustration of a partial, side view of a bottom of a single zone of a multi-zone pass-through system having sealing devices according to an embodiment of the invention.

### DETAILED DESCRIPTION OF THE INVENTION

Generally, perishable product is routinely harvested and processed in ways that do not always yield exceptional quality, condition or ripeness, and shelf life due to multiple root causes that originate with the technology available and practiced by the grower/shipper.

Perishable product that is packed in the field and/or a greenhouse in the final consumer package or market ready case is not cleaned, washed, or sanitized to reduce spoilage or pathogenic organisms that may be present on the surface. Additionally, typical produce cooling and distribution facilities operate seasonally during the climate driven growing and harvest seasons. These regional facilities are located within hours of the various harvest locations. The facilities have processing capacities according to their size, design, and configuration. Seasonally, these facilities may be strained operationally as a result of the seasonal nature of growing and harvesting. Product is often transited for several hours after harvest just to get to the cooling facility. Upon arrival, it may sit on the delivery truck awaiting to be received. It may then wait again to be positioned for precooling. There is typically no precooling with field and/or greenhouse packing. Many packing houses provide no precooling capability at all with a current purpose to just pack, ship, or transfer perishable products to cooling facilities. These operational strains delay getting the product to its intended shipping temperature. Harvest to cool time is one of the most critical process control points. Fruit, vegetable (produce), or cut flower respiration, which is a key indicator for the shelf life of harvested products, is greatly reduced by cooling the product to its lowest possible temperature before chill injury can occur. Produce demands timely and efficient processing. Delays in cooling are typically the primary root cause of quality issues that show up downstream in the market. A direct result is that frequently the perishable is harvested at a less mature stage of ripeness with organoleptic properties that do not match the products' potential eating condition quality or consumers' expectations.

The facility/warehouse operations that are performing the delayed precooling most often do not have rigorous cleaning and sanitization during the seasonal operation. As harvested products are brought into the cooling facility from the fields some of these products bring with them mold and micro-organisms contamination, and the contamination levels generally increase through the harvest season. Air is circulated throughout the cooling facility/warehouse and also forced across the perishables for precooling. Mold and other micro-organisms can accumulate in this air and on the warehouse and/or cooling equipment/process surfaces. This results in further contamination of the perishable product from airborne mold and spoilage organisms pushed through pallets during precooling.

In addition, air that is circulating throughout the warehouse and also forced across the perishables is typically low in relative humidity, as the cooling equipment condenses water from the air. This air, thus, dehydrates the perishable product(s) during precooling.

If only some of the perishable product is sanitized before cooling, then mixed with a contaminated product in a contaminated cold room and/or contaminated cooling air, any mold and micro-organisms removed during sanitizing will just be added back to the perishable product. If the perishable product is sanitized after cooling, then the sanitizing process has to reduce an even higher contamination load. In addition, separated non-integrated steps of sanitizing and precooling, product handling and product packaging, while possible, extend the overall process time and require additional handling and costs. Another key consideration is that when cooling air is shared within the cold storage warehouse with the precooling process, significant limitations are present that relate to operator safety and/or equipment surface corrosion. Moreover, many sanitizers and conditioning or ripeness management substances would not be permissible in such a cold storage warehouse.

The present disclosure relates to a pass-through system and method for applying functional treatments to the surface of a perishable product. The pass-through system and method can further allow for efficiently precooling perishable product, if desired. Forced air, including, e.g., cooling air and/or functional treatments, like, for example, sanitizing substances, are recirculated through pallets of perishable product that move through the pass-through system and across the surface of the perishable product. The treatments, including, e.g., dry-washing or cleaning (i.e., with a minimal amount of liquid or water), can be applied before, during, or after the process involved with precooling. Combining sanitizing with or without cooling immediately after harvest solves major current problems by quickly reducing the level of mold and other micro-organisms on the surface of perishables and then preventing cross-contamination of perishables during any enhanced rapid cooling process, if used. These capabilities are not possible or practical in current commercial cooling facilities. The pass-through system and process eliminates the continual introduction of field contaminated product into the commercial facility and prevents cross-contamination from cooling air that carry mold and other micro-organisms to the surface of perishables. The delivery of the treatments via the pass-through system and apparatus may be continual, intermittent, pulsed, sequential, or otherwise staged to effect maximum anti-microbial efficacy. Substances can be added to enhance product quality, safety, value, shelf-life, and/or manage the conditioning or ripeness of the perishable product. The pass-through system and methods can involve the use of a refrigerated container and/or a semi-trailer or pre-fabricated or modular container that is modified to add the refrigeration and/or air flow capability required for effectively recirculating the substances and/or rapidly cooling the product, and uses materials of construction compatible with the various sanitizers and substances that can be used. The key components of the pass-through system for supplying substance treatments and/or high capacity airflow are all modular and, thus, adaptable for various perishable and operational applications. The sanitizing capabilities of these systems can augment current sanitization, food, and worker safety programs prior to receiving products into facilities. These capabilities can be located at or nearer the actual harvest and production location and/or a greenhouse operation to shorten the time to begin this critical processing step.

Typical produce cooling and distribution facilities operate seasonally during the climate driven growing and harvest seasons. These expensive facilities are typically designed for produce volumes that anticipate a normal rate of product arriving for processing. The time from harvest to being cooled to the intended storage temperature is perhaps the most important postharvest process factor for quality and shelf life. In reality, produce arrives in surges during the day and the season in a way that cooling, and distribution facilities are generally not able to maintain the intended cooling standards. Under actual commercial cooling conditions, it is extremely difficult to maintain a completely constant air temperature. Warm fruit is constantly being brought into the cooler during operation, and forklifts must pass in and out of the cooler. This can result in the cooling facility temperature increasing or warming during the day, which slows the cooling process and even prevents the cooling systems from delivering the produce to its intended temperature. Because of the capacity challenges, regular cleaning and sanitation of the refrigeration and air flow systems is neglected, resulting in air that may contain mold spores and other spoilage organisms. Once airborne, these mold spores and/or organisms can cross-contaminate the produce coming through the facility, resulting in a product with mold and decay during the supply chain to the consumer. Thereafter, the entire impacted facility is left to remain underutilized or idle until the growing season returns.

Additionally, greenhouse facilities and/or packing house facilities that are designed to pack perishable product typically provide no precooling capability. The perishable product is then not cooled until transportation and delivery to a cold storage facility which could be miles, hours, or days away. Such locations could take advantage of effective precooling where the equipment required can be easily placed and put into operation to support harvest operations.

For example, current precooling systems for perishable produce are all “fixed in place” installations within cold-room warehouses. Air within these warehouses that is cooled via a central cooling system is forced through pallets of product that have been transported from a field to cool the product. The central cooling system of these warehouses is thus tasked to remove the field heat that comes out of the pallets of warm product and mixes with the warehouse air. The cold-room warehouses are not frequently sanitized to maintain low micro-organism presence as would be likely present in a perishable processing facility. Accordingly, spores of mold and other spoilage organisms brought in from the fields on some of the products are distributed in the cold warehouse air, thereby exposing and spreading these organisms to other products during the cooling of the product by the central cooling system.

As described above, current precooling systems in warehouses do not provide any type of sanitization to product that has been packed in the field. Their purpose is to cool the product to the target temperature for shipment. So, sanitization is a missing step in the process to produce and market perishable product with exceptional quality, shelf life and safety. It is a specific intention of this invention to provide a pass-through system and method where the perishable product is isolated from the warehouse and operating personnel, and the product can receive a treatment of substances that will reduce or eliminate mold and pathogenic or spoilage organisms. These substances typically have restrictions based upon personnel safety or equipment based on material of construction issues. In addition, there are numerous other reasons that these substances are not feasible and/or cost efficient to execute in current packaging, warehouse, and/or cooling operations. This dedicated space for providing treatment to the product, in which the product is isolated from the warehouse and operating personnel, can be designed to remedy those limitations or restrictions.

In view of the foregoing, the pass-through systems and methods described herein provide independent functional treatment and/or cooling to harvested perishable product. The pass-through systems and methods can augment or replace the air flow plenums or precooling systems currently located within the cold storage facility, freeing up space for produce storage during production peaks.

Most important of all is that the improved system is able to provide a currently missed step of sanitization to reduce, control, or eliminate mold, pathogenic, or spoilage organisms. Combining this with precooling ensures the perishable product is not cross-contaminated or re-contaminated within the warehouse.

The overall net result is improved quality from harvest to cool time, intended produce temperature, and/or reduced surface mold and/or spoilage organisms. The cooling operation has cooling assets that operate more cost efficiently (i.e., asset cost/carton processed), as well as increased storage space to manage surges in production.

In addition, a pass-through system that is capable of providing sanitization treatments and/or cooling is an ideal apparatus, method, and system to support, for example, the urban or global smart greenhouse industry. This industry is growing throughout the world due to the need to bring food production closer to the urban population centers, to enable throughout the year growing independent of seasonal weather, and to reduce the costs and lost freshness of extended transportation and logistics. Commercial greenhouses are high-tech structures, which provide stable, highly controlled environments for the cultivation of plants, such as, e.g., flowers, vegetables, and fruits to commercial growers. Environmental factors such as, e.g., temperature, light exposure, irrigation, fertilization, humidity, and ventilation can be precisely controlled by growers in smart greenhouses for the optimal growth of crops. Commercial smart greenhouses enable the cultivation of plants in large volumes for commercial growers. These greenhouses maintain mid-to-high temperatures (often between 45° F. and 100° F., depending on plants being cultivated or the season of the year) using glass or plastic materials to enable the transmission of visible and near-visible ultraviolet (UV) and/or infrared radiation (IR). Another approach to indoor plant growing involves indoor and vertical farms using repurposed buildings, warehouses, or vacant properties. In all cases, a solution is needed for proper post-harvest processing of the perishables. Thus, by providing a pass-through system, which can be located at the receiving and shipping dock of these types of facilities, minimal facility modifications would be needed. Importantly, as a programmable system, the necessary sanitization materials used and/or cooling conditions (including, e.g., precooling) can be prescribed for the operation. The pass-through system can be simply connected to the operation and will function to provide state of the art functional treatments (such as, e.g., sanitization) and/or cooling for the perishables to enhance their quality, safety, and provide extended shelf life for consumers.

In a similar fashion, meat and other proteins are being produced at smaller, more local facilities instead of conventional large, regional packing houses. Accordingly, the above-discussed pass-through systems and methods with cooling and/or non-thermal or cold treatment capabilities can be utilized for these products. In particular, because the pass-through system can be located outside of the facility and not inside where personnel are present, there is a broader list of materials that can be used to treat the surface of the protein products. Carriers such as, e.g., liquid nitrogen and carbon dioxide can also be used to deliver functional treatments, such as, e.g., sanitizers, to the surfaces of the products. According to one embodiment, non-thermal treatments (i.e., treatments not requiring heat or heating, raising the temperature, or exposing the perishable product to higher temperatures) that can be utilized for meat and other protein products (as well as other perishable products, including, e.g., produce products and other non-meat or non-protein products) include directed electrical energy, electrical pulses, ultra-sound, UV light, and/or electromagnetic treatments, whereby they activate substances already applied to the surface of the product, and/or are used as standalone substance treatments by impacting the electrons and subsequently damage or destroy microorganisms or convert pesticides or other substances or undesirable chemical compounds into harmless compounds.

Accordingly, one embodiment includes a mobile, modular pass-through system for treating and/or cooling a perishable product to its intended condition (including, e.g., its intended temperature). The system comprises (a) at least one plenum, (b) at least one axial fan attached to the at least one plenum, the at least one axial fan configured to recirculate forced air through one or more pallets of perishable product and across perishable products contained on the one or more pallets of perishable product, (c) one or more sealing mechanisms configured to contain and channel the forced air being recirculated between the at least one plenum and through the one or more pallets of perishable product and across the perishable products contained on the one or more pallets of perishable product, (d) at least one treatment delivery mechanism (device or apparatus), (e) one or more conveyors configured to move the one or more pallets of perishable product through the pass-through system, and (f) a treatment chamber configured to provide a sealed environment (i.e., is contained or closed) for treating and/or cooling the perishable product.

According to an embodiment, the pass-through system can be located at seasonal or temporary operations for treating perishable products.

Another embodiment includes one or more methods and/or systems for treating a perishable product and/or using the various apparatus described herein.

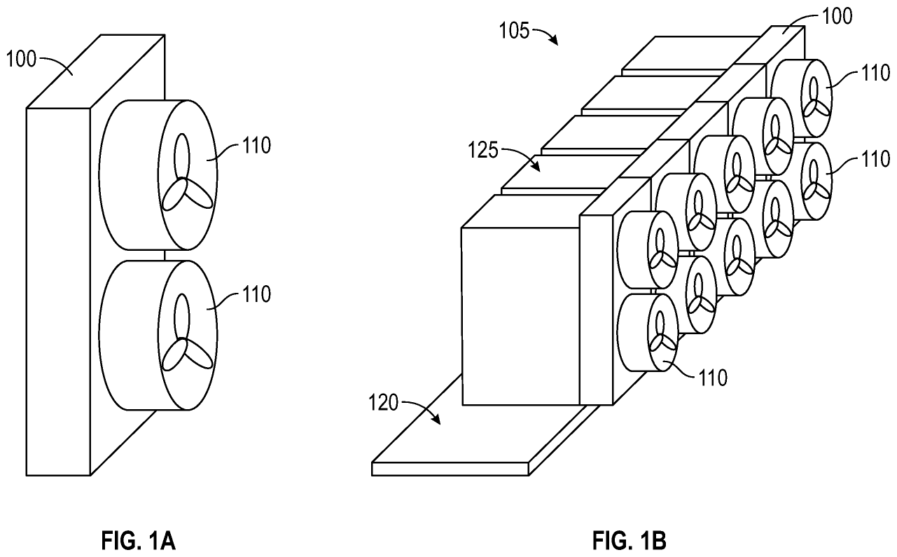

FIG. 1A illustrates a plenum having a pair of axial fans for delivering forced air (including, e.g., cooling air) through the plenum according to an embodiment of the invention. As shown in FIG. 1A, the plenum (100) includes the pair of axial fans (110) attached to an exterior surface of the plenum (100). This plenum (100) can be combined with a plurality of plenums for creating a pass-through system according to an embodiment of the invention (see, e.g., FIG. 1B).

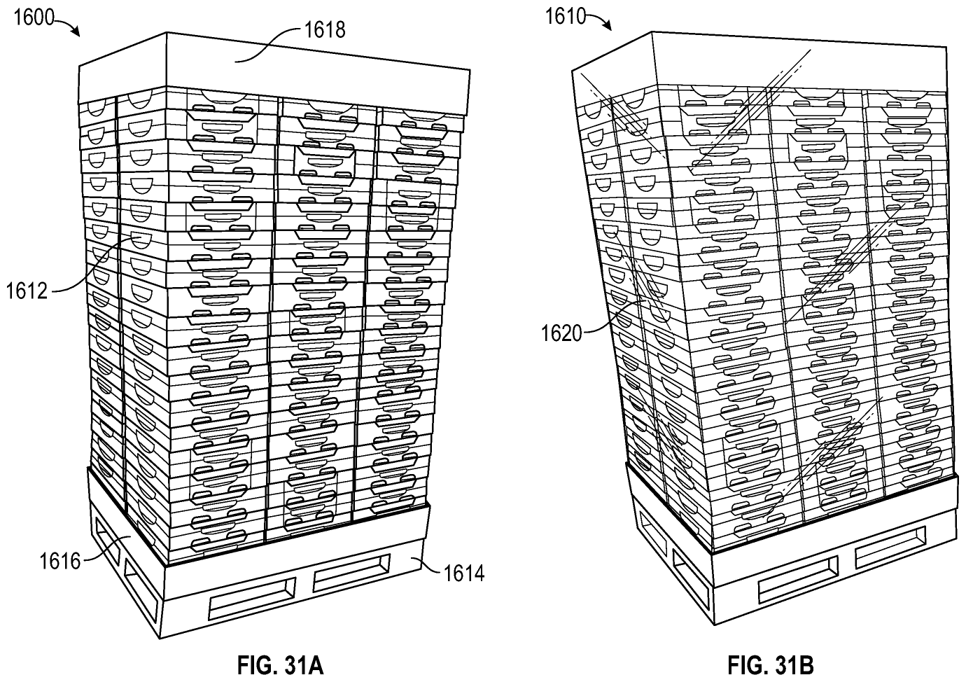

FIG. 1B illustrates the plenum (100) of FIG. 1A being combined with a plurality of plenums for creating a pass-through system for providing forced air (including, e.g., cooling air) to multiple pallets of perishable product according to an embodiment of the invention. As shown in FIG. 1B, the pass-through system (105) includes a plurality of plenums (100) that each includes at least two axial fans (110) attached to an exterior surface thereof. The plurality of plenums (100) are attached to a conveyor (120) that is configured to move one or more pallets (125) of perishable product through the pass-through system (105). According to one embodiment, the conveyor (120) comprises at least one of, e.g., a roller conveyor or a chain drive conveyor. The conveyor (120) is configured to move the one or more pallets (125) of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (120) can also be configured to reverse direction so that treated pallets exit the system on the same side as they entered. As the pallets (125) of perishable product move along the conveyor (120), forced air (including, e.g., cooling air) is circulated or recirculated across the pallets (125) of perishable product via the axial fans (110) attached to the respective plenums (100). According to the embodiment of FIG. 1B, the pass-through system (105) provides a plenum system for a batch of multiple pallets (125). According to an embodiment, which is described in further detail below, the pallets of perishable product include a top sheet or top cap, a bottom sheet or cap, or a combination thereof, to contain and/or channel the forced air being circulated or recirculated across the pallets of perishable product via the axial fan(s) (see, e.g., FIGS. 31A and 31B).

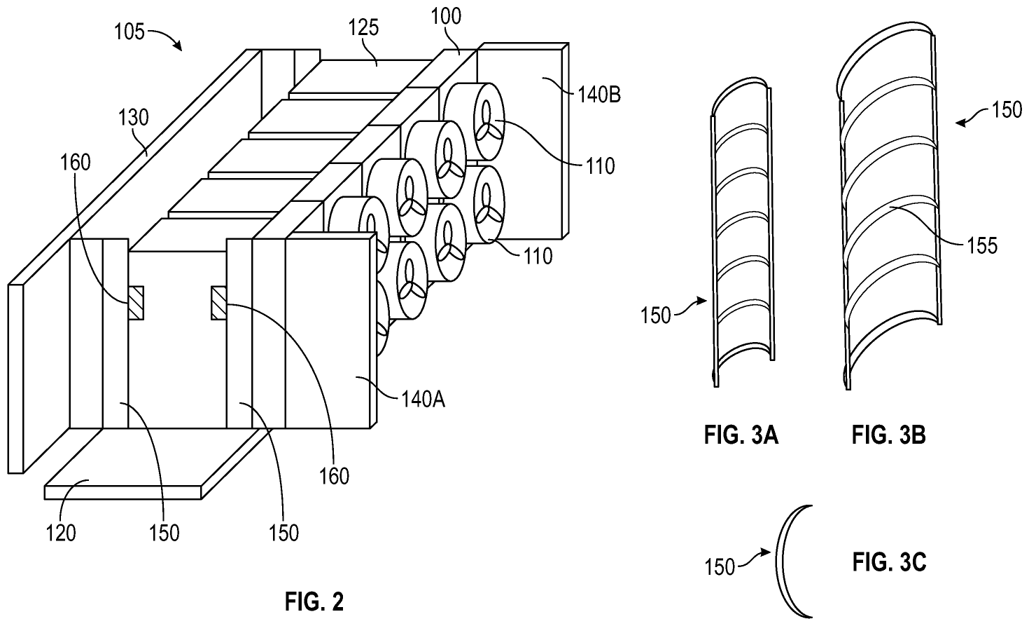

FIG. 2 illustrates a complete version of the pass-through system (105) shown in FIG. 1B. As shown in FIG. 2, the pass-through system (105) includes the plurality of plenums (100) that each includes at least two axial fans (110) attached to an exterior surface thereof. The plurality of plenums (100) are attached to a conveyor (120) (such as, e.g., a roller conveyor) that is configured to move one or more pallets (125) of perishable product through the pass-through system (105). As discussed above, the conveyor (120) is configured to move the one or more pallets (125) of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (120) can also be configured to reverse direction so that treated pallets exit the system on the same side as they entered. The pass-through system (105) further includes a sidewall (130), along with a front closing door (140A) and a back closing door (140B) to provide a contained treatment zone in which the pallets (125) of perishable product can be treated with functional treatments, such as, e.g., sanitizing substances, and/or cooled. As the pallets (125) of perishable product move along the conveyor (120), forced air (including, e.g., cooling air) is circulated or recirculated across the pallets (125) of perishable product via the axial fans (110) attached to the respective plenums (100). Also included with the pass-through system (105) of FIG. 2 are at least two spring-loaded, arced-wing baffles (150). These spring-loaded, arced-wing baffles (150), which are further illustrated in FIGS. 3A-3C, are configured to seal the pass-through system (105) along the sides/ends of the system, e.g., along a side of the plenums (100) and a side of the sidewall (130). These spring-loaded, arced-wing baffles (150) include a plurality of support members (155) in order to create sturdy, upright baffles (150) that are configured to move in and out depending on the operation of the system (see, e.g., FIG. 3B). These spring-loaded, arced-wing baffles (150) (or other suitable baffles) can be actuated and/or controlled manually or automatically as programmed using one or more combinations of air flow pressure/suction, springs, hydraulic cylinders, air cylinders, mechanical or robotic devices, weights, chains and cables, and motors/drives. According to the embodiment of FIG. 2, the pass-through system (105) provides a plenum system for a batch of multiple pallets (125).

According to one embodiment, the pass-through system (105) of FIG. 2 includes one or more sensors (160) configured to identify the type(s) of perishable product in the pallets (125) of perishable product to thereby control the treating and/or cooling of the perishable product. According to one embodiment, the one or more sensors (160) comprise scanners that scan a barcode(s) included with the pallets (125) of perishable product(s), which allows for identifying the type(s) of perishable product(s) on each of the pallets (125). According to another embodiment, the pass-through system (105) of FIG. 2 further includes a control system (not shown) configured to control the treating and/or cooling of the perishable product based on the type(s) of perishable product identified by the one or more sensors (160). According to yet another embodiment, the control system is configured to control the treating and/or cooling of the perishable product based on machine learning related to treating and/or cooling of a previously-treated perishable product based on a type of the previously-treated perishable product.

According to an embodiment, the system (including, e.g., the pass-through system (105) of FIG. 2) is configured to treat the perishable product (i) before the perishable product is cooled, (ii) while the perishable product is being cooled, or (iii) after the perishable product is cooled.

According to an embodiment, the system (including, e.g., the pass-through system (105) of FIG. 2) is configured to treat the perishable product without applying heat (i.e., non-thermally).

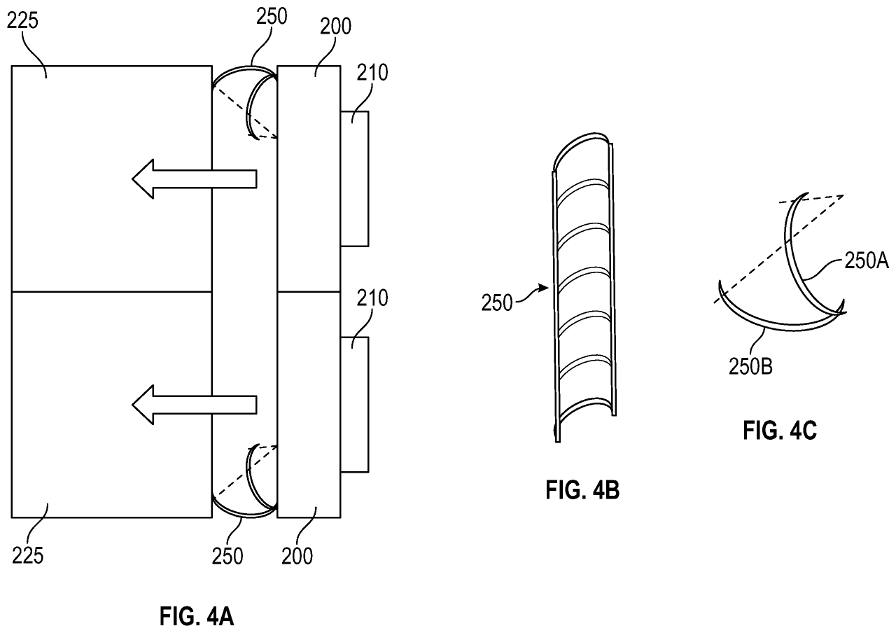

FIG. 4A illustrates a top view of a portion of a pass-through system using forced air flow according to an embodiment of the invention. As shown in FIG. 4A, a pair of plenums (200) are illustrated that each includes at least one axial fan (210) attached thereto. Forced air flow (as shown by arrows illustrated in FIG. 4A) that is delivered through the plenums (200) via the axial fans (210) is forced across pallets (225) in order to, for example, treat and/or cool perishable products included within the pallets (225). Positioned between the plenums (200) and the pallets (225) are a pair of spring-loaded arc-wing baffle (250), with a baffle (250) included at each end of the plenums (200). The spring-loaded, arc-wing baffles (250), which are further illustrated in FIG. 4B, are movable with respect to the forced air flow. In particular, positive air flow from the fans (210) pushes the spring-loaded, arc-wing baffles (250) into place in order to create a seal with the pallets (225). Once the air flow is removed by turning off the fans (210), the spring-loaded, arc-wing baffles (250) relax, which enables free movement of the pallets (225). For example, as shown in FIG. 4C, when the fans (210) are turned on, the positive air flow pushes the spring-loaded, arc-wing baffles (250) into place against the pallets (225), which pulls on/extends the springs of the spring-loaded, arc-wing baffles (250) (see, e.g., position of baffle 250B in FIG. 4C). However, as further shown in FIG. 4C, when the fans (210) are turned off, the air flow is removed and the springs of the spring-loaded, arc-wing baffles (250) retract and pull the baffles (250) into the relaxed or original position, which is away from the pallets (225) (see, e.g., position of baffle 250A in FIG. 4C).

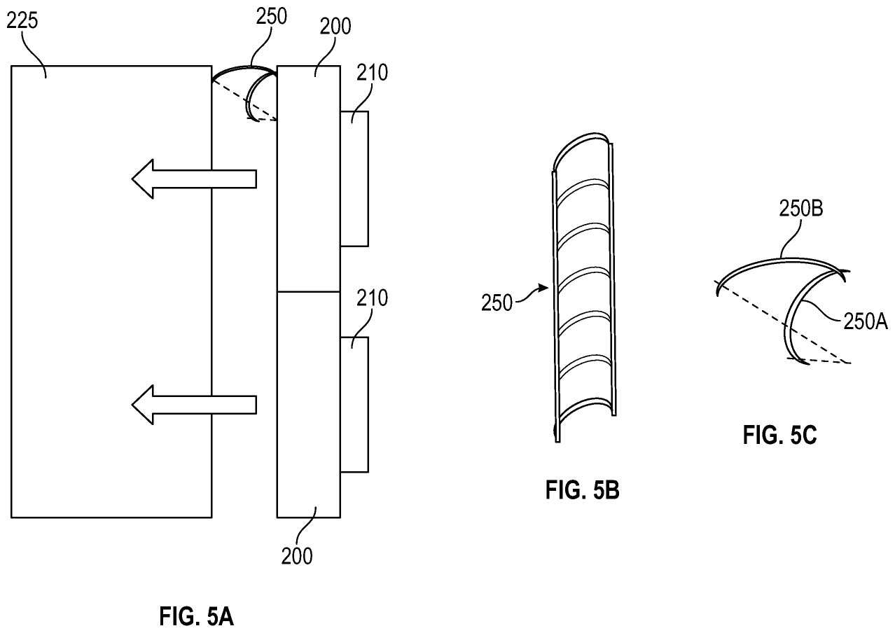

FIG. 5A illustrates an end view of the portion of the pass-through system of FIG. 4A. As shown in FIG. 5A, a pair of plenums (200) are illustrated that each includes at least one axial fan (210) attached thereto. Forced air flow (as shown by arrows illustrated in FIG. 5A) that is delivered through the plenums (200) via the axial fans (210) is forced across a pallet (225) in order to, for example, treat and/or cool perishable products included within the pallet (225). Positioned at the top of the upper plenum (200) and between the upper plenum (200) and the pallet (225) is a spring-loaded arc-wing baffle (250). The spring-loaded, arc-wing baffle (250), which is further illustrated in FIG. 5B, is movable with respect to the forced air flow. In particular, positive air flow from the fans (210) pushes the spring-loaded, arc-wing baffle (250) into place in order to create a seal with the pallet (225). Once the air flow is removed by turning off the fans (210), the spring-loaded, arc-wing baffle (250) relaxes, which enables free movement of the pallet(s) (225). For example, as shown in FIG. 5C, when the fans (210) are turned on, the positive air flow pushes the spring-loaded, arc-wing baffle (250) into place against the pallet (225), which pulls on/extends the spring of the spring-loaded, arc-wing baffle (250) (see, e.g., position of baffle 250B in FIG. 5C). However, as further shown in FIG. 5C, when the fans (210) are turned off, the air flow is removed and the spring of the spring-loaded, arc-wing baffle (250) retracts and pulls the baffle (250) into the relaxed or original position, which is away from the pallet (225) (see, e.g., position of baffle 250A in FIG. 5C). According to the embodiments described herein, the term “spring-loaded” baffle or device is an example of a simple preferred device and method for channeling air-flow carried treatments and/or cooling to perishable product when used in combination with a fan-generated air pressure/suction. Other devices or combination of devices for efficiently channeling and containment of treatments and/or cooling airflow can be substituted as needed to achieve the prescribed product outcomes.

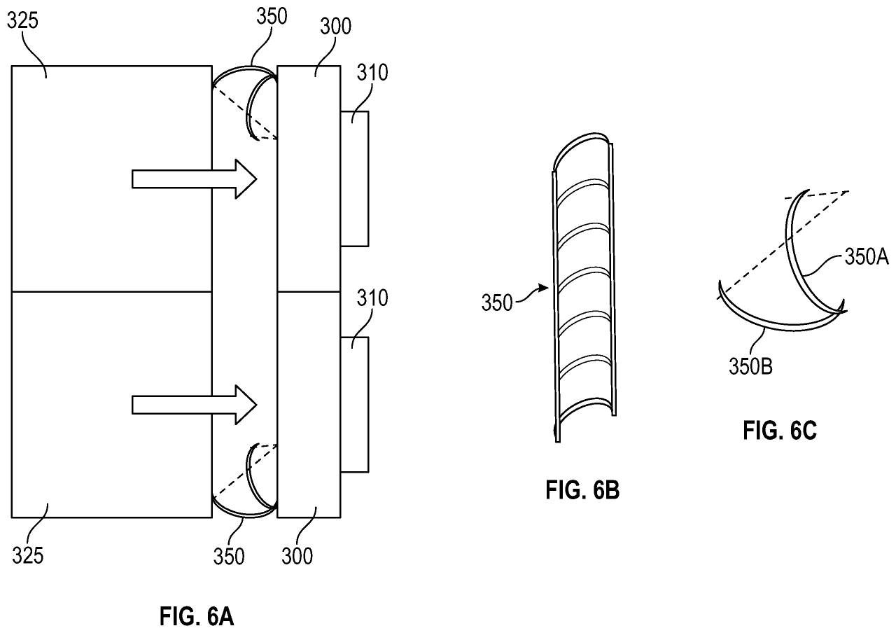

FIG. 6A illustrates a top view of a portion of a pass-through system using suction air flow according to an embodiment of the invention. As shown in FIG. 6A, a pair of plenums (300) are illustrated that each includes at least one axial fan (310) attached thereto. Suction air flow (as shown by arrows illustrated in FIG. 6A) that is pulled through the plenums (300) via the axial fans (310) is pulled across pallets (325) in order to, for example, treat and/or cool perishable products included within the pallets (325). Positioned between the plenums (300) and the pallets (325) are a pair of spring-loaded arc-wing baffle (350), with a baffle (350) included at each end of the plenums (300). The spring-loaded, arc-wing baffles (350), which are further illustrated in FIG. 6B, are movable with respect to the suction air flow. In particular, suction air flow from the fans (310) pushes the spring-loaded, arc-wing baffles (350) into place in order to create a seal with the pallets (325). Once the suction air flow is removed by turning off the fans (310), the spring-loaded, arc-wing baffles (350) relax or swing away from the pallets (325), which enables free movement of the pallets (325). For example, as shown in FIG. 6C, when the fans (310) are turned on, the suction air flow pushes the spring-loaded, arc-wing baffles (350) into place against the pallets (325), which pushes the springs of the spring-loaded, arc-wing baffles (350) (see, e.g., position of baffle 350B in FIG. 6C). However, as further shown in FIG. 6C, when the fans (310) are turned off, the suction air flow is removed and the springs of the spring-loaded, arc-wing baffles (350) retract and pull the baffles (350) into the relaxed or original position, which is away from the pallets (325) (see, e.g., position of baffle 350A in FIG. 6C).

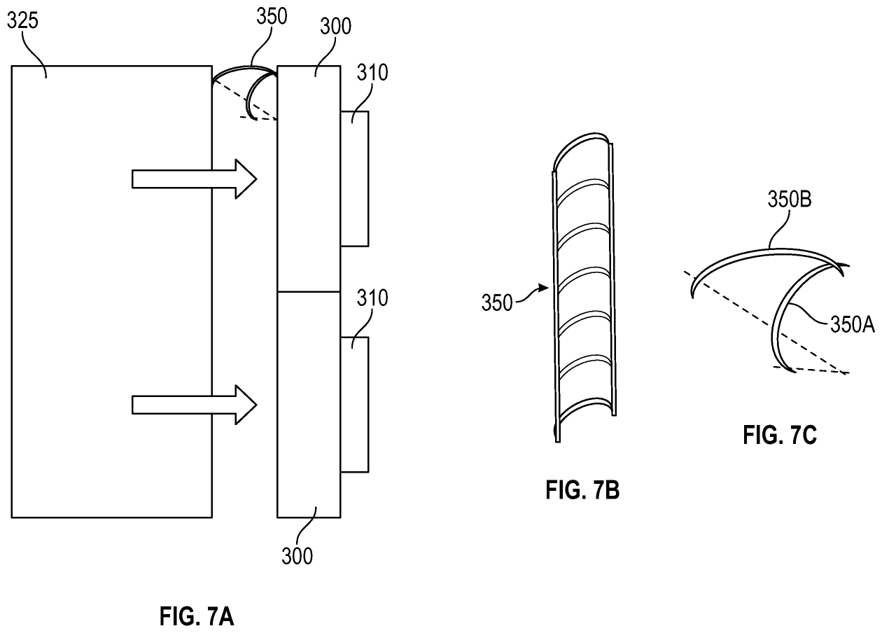

FIG. 7A illustrates an end view of the portion of the pass-through system of FIG. 6A. As shown in FIG. 7A, a pair of plenums (300) are illustrated that each includes at least one axial fan (310) attached thereto. Suction air flow (as shown by arrows illustrated in FIG. 7A) that is pulled through the plenums (300) via the axial fans (310) is pulled across a pallet (325) in order to, for example, treat and/or cool perishable products included within the pallet (325). Positioned at the top of the upper plenum (300) and between the upper plenum (300) and the pallet (325) is a spring-loaded arc-wing baffle (350). The spring-loaded, arc-wing baffle (350), which is further illustrated in FIG. 7B, is movable with respect to the suction air flow. In particular, suction air flow from the fans (310) pushes the spring-loaded, arc-wing baffle (350) into place in order to create a seal with the pallet (325). Once the suction air flow is removed by turning off the fans (310), the spring-loaded, arc-wing baffle (350) relaxes or swings away from the pallet (325), which enables free movement of the pallet(s) (325). For example, as shown in FIG. 7C, when the fans (310) are turned on, the suction air flow pushes the spring-loaded, arc-wing baffle (350) into place against the pallet (325), which pushes the spring of the spring-loaded, arc-wing baffle (350) (see, e.g., position of baffle 350B in FIG. 7C). However, as further shown in FIG. 7C, when the fans (310) are turned off, the suction air flow is removed and the spring of the spring-loaded, arc-wing baffle (350) retracts and pulls the baffle (350) into the relaxed or original position, which is away from the pallet (325) (see, e.g., position of baffle 350A in FIG. 7C).

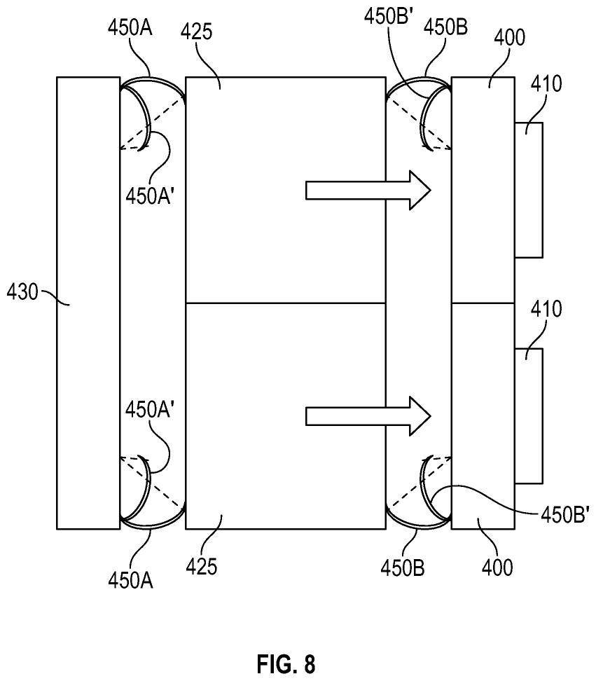

FIG. 8 illustrates a top view of a portion of a pass-through system using suction air flow according to an embodiment of the invention. As shown in FIG. 8, a pair of plenums (400) are illustrated that each includes at least one axial fan (410) attached thereto. Suction air flow (as shown by arrows illustrated in FIG. 8) that is pulled through the plenums (400) via the axial fans (410) is pulled across pallets (425) in order to, for example, treat and/or cool perishable products included within the pallets (425). Positioned on the opposite side of the pallets (425) from the plenums (400) is a sidewall (430) for creating a contained treatment area/zone with the pallets (425). Positioned between the plenums (400) and the pallets (425) are a pair of spring-loaded arc-wing baffles (450B), with a baffle (450B) included at each end of the plenums (400). Positioned between the sidewall (430) and the pallets (425) are another pair of spring-loaded arc-wing baffles (450A), with a baffle (450A) included at each end of the sidewall (430). The spring-loaded, arc-wing baffles (450A, 450B) are movable with respect to the suction air flow. In particular, for a left side seal between the sidewall (430) and the pair of spring-loaded arc-wing baffles (450A), suction air flow from the fans (410) pulls the arc-wing baffles (450A) into place to create a side seal with the pallets (425) (see, e.g., position of arc-wing baffles (450A) in FIG. 8). Once the suction air flow is removed by turning off the fans (410), the springs of the spring-loaded, arc-wing baffles (450A) pull the baffles (450A) away from the pallets (425) (see, e.g., position of arc-wing baffles (450A′) in FIG. 8), which enables free movement of the pallets (425). In order to create a right side seal between the plenums (400) and the other pair of spring-loaded arc-wing baffles (450B), suction air flow from the fans (410) pushes the spring-loaded, arc-wing baffles (450B) into place in order to create a seal with the pallets (425) (see, e.g., position of arc-wing baffles (450B) in FIG. 8). Once the suction air flow is removed by turning off the fans (410), the springs of the spring-loaded, arc-wing baffles (450B) relaxes or releases the baffles (450B) (see, e.g., position of arc-wing baffles (450B′) in FIG. 8), which enables free movement of the pallets (425).

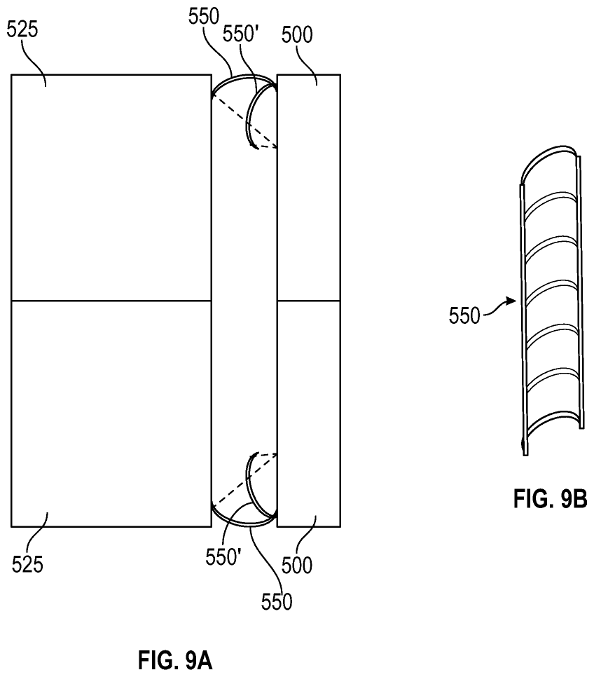

FIG. 9A illustrates a top view of a portion of a pass-through system according to an embodiment of the invention. As shown in FIG. 9A, a pair of plenums (500) are illustrated that can include at least one axial fan (not shown) attached thereto. Suction air flow or forced air flow can be pulled or forced through the plenums (500) in order to, for example, treat and/or cool perishable products included within pallets (525). Positioned between the plenums (500) and the pallets (525) are a pair of spring-loaded arc-wing baffles (550), with a baffle (550) included at each end of the plenums (500). The spring-loaded, arc-wing baffles (550), which are further illustrated in FIG. 9B, are movable with respect to the air flow (see, e.g., first position of arc-wing baffles (550) versus second position of arc-wing baffles (550′), as discussed above.

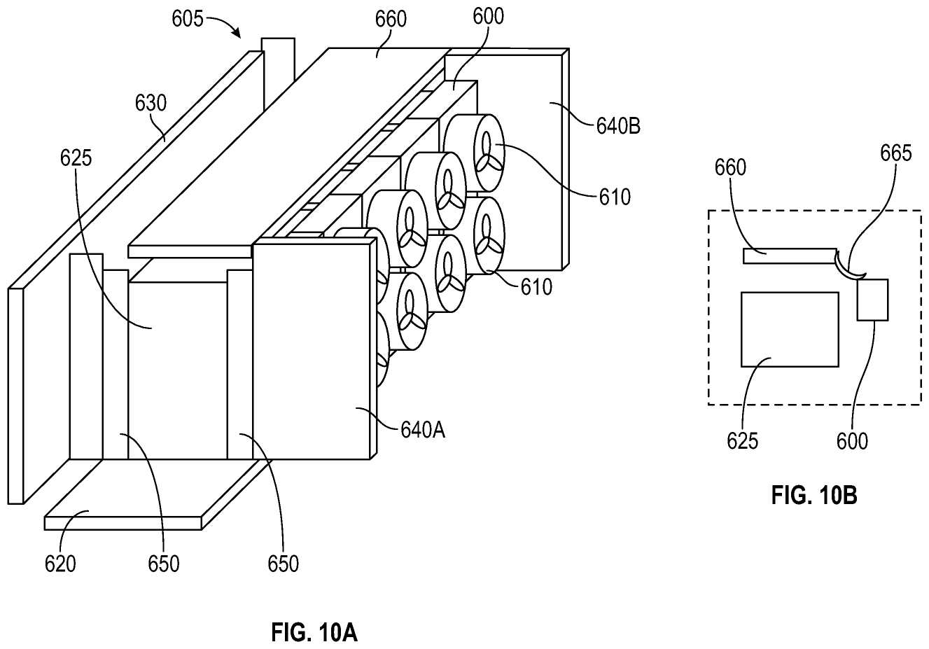

FIGS. 10A and 10B illustrate a pass-through system having a top sealing system for providing forced air (including, e.g., cooling air) to multiple pallets of perishable product according to an embodiment of the invention. As shown in FIG. 10A, the pass-through system (605) includes a plurality of plenums (600) that are each provided with at least two axial fans (610) attached to an exterior surface thereof. The plurality of plenums (600) are attached to a conveyor (620) (e.g., a roller conveyor) that is configured to move one or more pallets (625) of perishable product through the pass-through system (605). As discussed, the conveyor (620) is configured to move the one or more pallets (625) of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (620) can also be configured to reverse direction so that treated pallets exit the system on the same side as they entered. The pass-through system (605) further includes a sidewall (630), along with a front closing door (640A) and a back closing door (640B) to provide a contained (or closed) treatment zone in which the pallets (625) of perishable product can be treated with functional treatments, such as, e.g., sanitizing substances, and/or cooled. As the pallets (625) of perishable product move along the conveyor (620), forced air (including, e.g., cooling air) and/or suction air is circulated or recirculated across the pallets (625) of perishable product via the axial fans (610) attached to the respective plenums (600). Also included with the pass-through system (605) of FIG. 10A are at least two spring-loaded, side tarps/baffles (650), as well as an elevated top roller tarp and containment box (660). The spring-loaded, side tarps/baffles (650), which can comprise the configurations for the spring-loaded, arc-wing baffles described above, are configured to seal the pass-through system (605) along the sides/ends of the system, e.g., along a side of the plenums (600) and a side of the sidewall (630). The elevated top roller tarp and containment box (660), which is further illustrated in FIG. 10B, is positioned above the pallets (625), with a portion of the tarp (665) being connected to the plenums (600) along a top side thereof. By including both the spring-loaded, side tarps/baffles (650) and the elevated top roller tarp and containment box (660), the pass-through system (605) can be both side-sealed and top-sealed, in order to provide a contained treatment zone in which the pallets (625) of perishable product can be treated with functional treatments, such as, e.g., sanitizing substances, and/or cooled. According to the embodiment of FIGS. 10A and 10B, the pass-through system (605) provides a top sealing system for a batch of multiple pallets (625).

According to an embodiment, the pass-through systems described herein can allow for various dwell times in the treatment chamber and/or a treatment zone for treating and/or cooling a perishable product depending on the product. For example, through the pass-through systems and/or processes described herein, various substance treatments (such as, e.g., ethephon, ethrel, or lauryl alcohol) can be efficiently applied and/or deposited in a controlled manner onto the surface of perishable product in a delivery process of less than 1 minute to 10 minutes that will ultimately yield a ripeness response that conventionally takes many hours to one or more days in a more costly ripening room. Thus, the pass-through systems and/or processes described herein can provide dwell times that allow for seconds to minutes of substance treatment and/or application as compared to the hours or days required in current cooling and/or treatment operation. Moreover, the pass-through systems and/or processes described herein can provide a faster, contained, and controlled method for depositing substances/materials to the surface of a perishable product with an intended residual and enduring benefit (such as, e.g., essential oils) versus only an instantaneous impact.

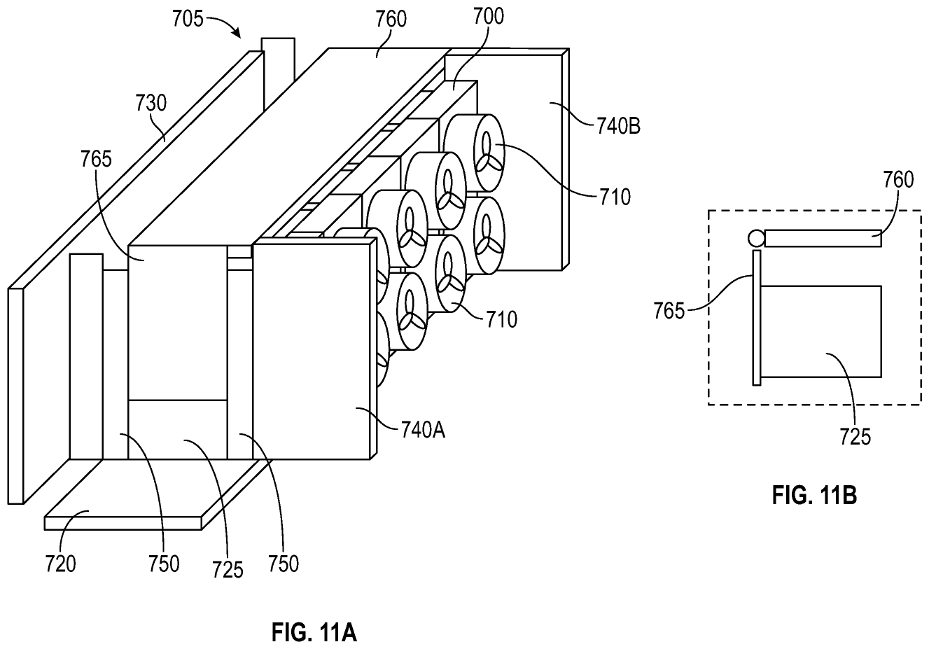

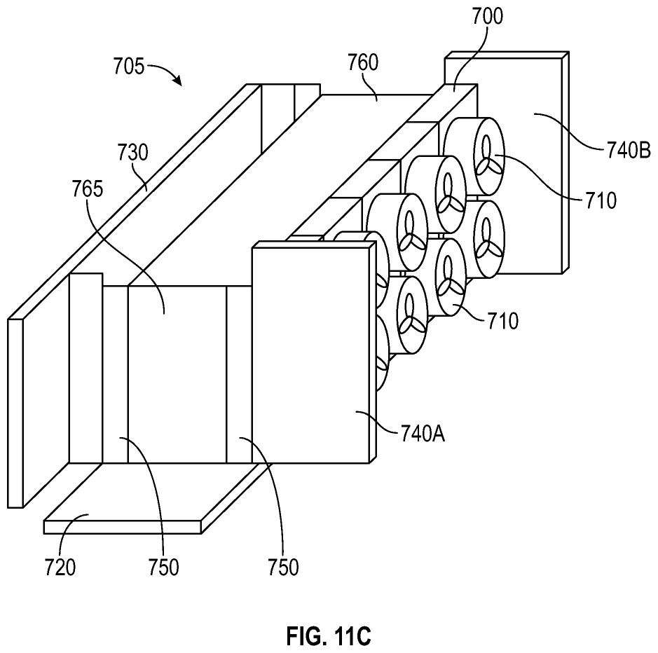

FIGS. 11A-11C illustrate a pass-through system having a front and back sealing system for providing forced air (including, e.g., cooling air) to multiple pallets of perishable product according to an embodiment of the invention. As shown in FIG. 11A, the pass-through system (705) includes a plurality of plenums (700) that are each provided with at least two axial fans (710) attached to an exterior surface thereof. The plurality of plenums (700) are attached to a conveyor (720) (e.g., a roller conveyor) that is configured to move one or more pallets (725) of perishable product through the pass-through system (705). As discussed, the conveyor (720) is configured to move the one or more pallets (725) of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (720) can also be configured to reverse direction so that treated pallets exit the system on the same side as they entered. The pass-through system (705) further includes a sidewall (730), along with a front closing door (740A) and a back closing door (740B) to provide a contained treatment zone in which the pallets (725) of perishable product can be treated with functional treatments, such as, e.g., sanitizing substances, and/or cooled. As the pallets (725) of perishable product move along the conveyor (720), forced air (including, e.g., cooling air) and/or suction air is circulated or recirculated across the pallets (725) of perishable product via the axial fans (710) attached to the respective plenums (700). Also included with the pass-through system (705) of FIG. 11A are at least two spring-loaded, side tarps/baffles (750), as well as an elevated top roller tarp and containment box (760) attached to a roll-down tarp (765), which is illustrated in a partially extended position in FIG. 11A. The spring-loaded, side tarps/baffles (750), which can comprise the configurations for the spring-loaded, arc-wing baffles described above, are configured to seal the pass-through system (705) along the sides/ends of the system, e.g., along a side of the plenums (700) and a side of the sidewall (730). The elevated top roller tarp and containment box (760) with the roll-down tarp (765), which are further illustrated in FIG. 11B, are positioned above the pallets (725), with the roll-down tarp (765) being configured to be pulled down in front of the pallets (725). For example, as shown in FIG. 11A, the roll-down tarp (765) is partially extended down in front of the pallets (725). Thereafter, as shown in FIG. 11C, the roll-down tarp (765) is fully extended down in front of the pallets (725), such that the pallets (725) are no longer visible. Once the roll-down tarp (765) is fully extended down in front of the pallets (725), as shown in FIG. 11C, the pallets (765) are sealed are ready for treatment. Although only a front roll-down tarp (765) is illustrated in FIG. 11A and FIG. 11C, a back roll-down tarp (not shown) could also be included along the end where the back closing door (740B) is included. By including the spring-loaded, side tarps/baffles (750) and the elevated top roller tarp and containment box (660) with roll-down tarp (765), the pass-through system (705) can be both side-sealed and top-sealed, as well as front-sealed and back-sealed, in order to provide a completely contained treatment zone in which the pallets (725) of perishable product can be treated with functional treatments, such as, e.g., sanitizing substances, and/or cooled. According to the embodiment of FIGS. 11A-11C, the pass-through system (705) provides a front and back sealing system for a batch of multiple pallets (725).

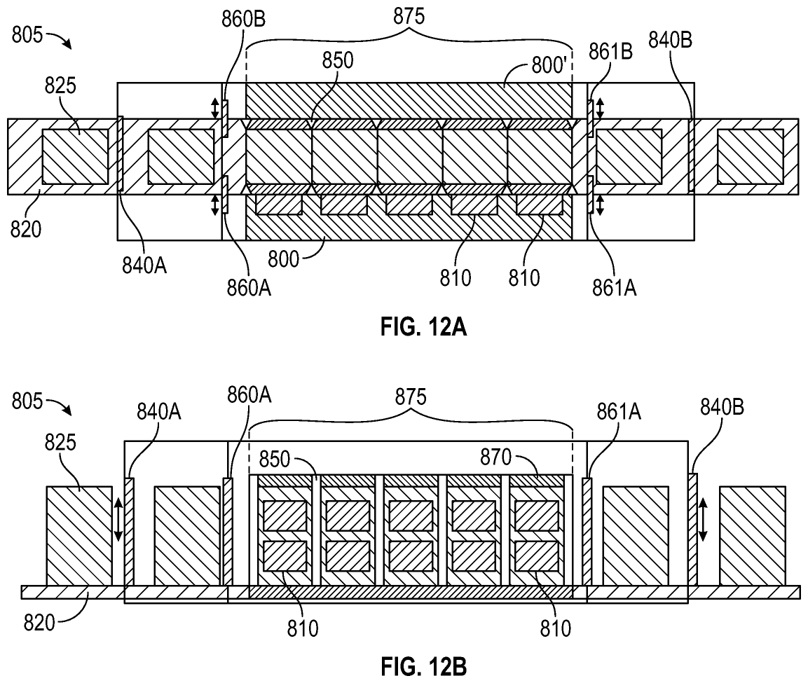

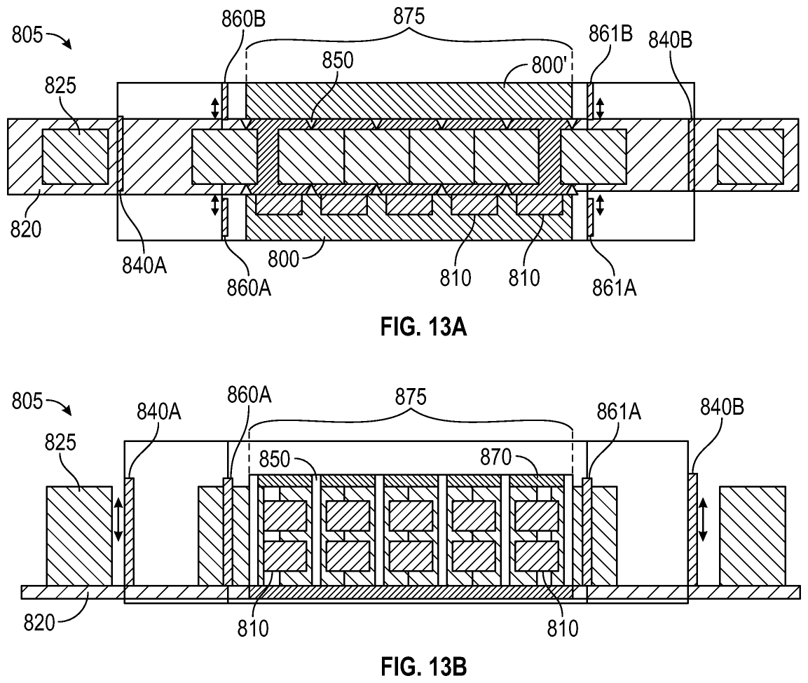

FIGS. 12A, 12B, 13A, and 13B illustrate a pass-through system having extra containment doors and modules (or transition zones) for providing forced air (including, e.g., cooling air) to multiple pallets of perishable product according to an embodiment of the invention. As shown in FIGS. 12A, 12B, 13A, and 13B, the pass-through system (805) includes a plenum (800) that is provided with a plurality of axial fans (810) attached thereto. Positioned on an opposite side to the plenum (800) is another plenum (800′) that does not include any axial fans. The plenums (800, 800′) are attached to a conveyor (820) that is positioned between the plenums (800, 800′). The conveyor (820) is configured to move one or more pallets (825) of perishable product through the pass-through system (805). As discussed, the conveyor (820) is configured to move the one or more pallets (825) of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (820) can also be configured to reverse direction so that treated pallets exit the system on the same side as they entered. The pass-through system (805) further includes a plurality of angled pressure baffles/rollers/sweep wings (850) (or similar devices) for channeling air flow through the perishable product included on the pallets (825), while the pallets (825) are moving or paused in the pass-through system (805). The angled pressure baffles/rollers/sweep wings (850), which can comprise the configurations for the spring-loaded, arc-wing baffles described above, are configured to seal the pass-through system (805) along the sides/ends of the system, while also channeling air flow as discussed above. Also included with the pass-through system (805) is a top wall (870), a front closing door (840A), a back closing door (840B), a pair of front secondary doors (860A, 860B), and a pair of back secondary doors (861A, 861B) to provide a contained treatment zone (875) in which the pallets (825) of perishable product can be treated with functional treatments, such as, e.g., sanitizing substances, and/or cooled. For example, as shown in the embodiment of FIGS. 12A, 12B, 13A, and 13B, the front closing door (840A) and the back closing door (840B) are configured to move up and down as the pallets (825) of perishable product are moved into the contained treatment zone (875) via the conveyor (820). By contrast, the pair of front secondary doors (860A, 860B) and the pair of back secondary doors (861A, 861B) are configured to move in and out (e.g., across or perpendicular to the conveyor (820)), as the pallets (825) of perishable product are moved into the contained treatment zone (875) via the conveyor (820). As the pallets (825) of perishable product move along the conveyor (820), and are thereafter closed or sealed within the contained treatment zone (875), by closing one or more of the front closing door (840A), the back closing door (840B), the pair of front secondary doors (860A, 860B), and the pair of back secondary doors (861A, 861B), forced air (including, e.g., cooling air) and/or suction air, as well as functional treatments, such as, e.g., sanitizing substances, are circulated or recirculated across the pallets (825) of perishable product via the axial fans (810) attached to the respective plenum (800).

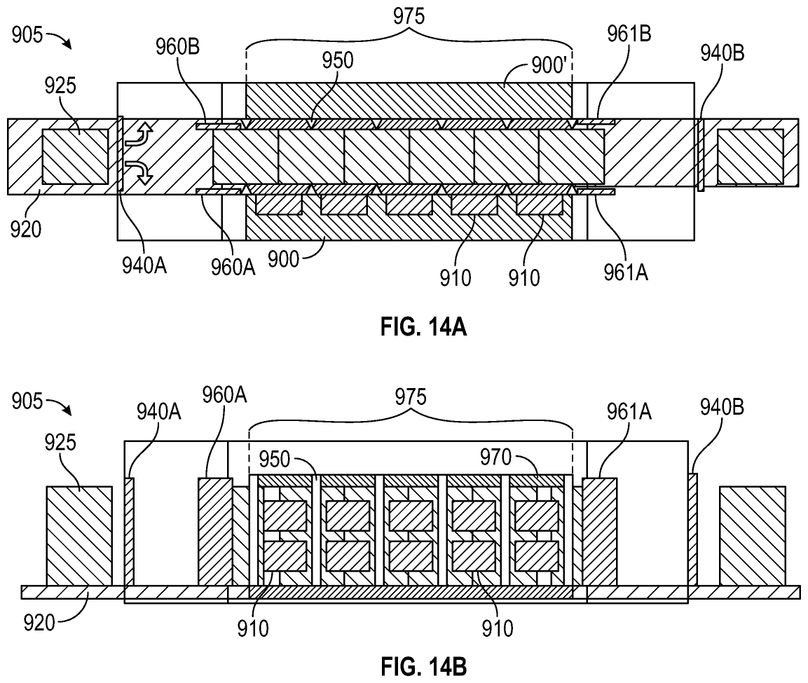

FIGS. 14A and 14B illustrate a pass-through system having extra swing seal doors and containment zones/modules for providing forced air (including, e.g., cooling air) to multiple pallets of perishable product according to an embodiment of the invention. As shown in FIGS. 14A and 14B, the pass-through system (905) includes a plenum (900) that is provided with a plurality of axial fans (910) attached thereto. Positioned on an opposite side to the plenum (900) is another plenum (900′) that does not include any axial fans. The plenums (900, 900′) are attached to a conveyor (920) that is positioned between the plenums (900, 900′). The conveyor (920) is configured to move one or more pallets (925) of perishable product through the pass-through system (905). As discussed, the conveyor (920) is configured to move the one or more pallets (925) of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (920) can also be configured to reverse direction so that treated pallets exit the system on the same side as they entered. The pass-through system (905) further includes a plurality of angled pressure baffles/rollers/sweep wings (950) (or similar devices) for channeling air flow through the perishable product included on the pallets (925), while the pallets (925) are moving or paused in the pass-through system (905). The angled pressure baffles/rollers/sweep wings (950), which can comprise the configurations for the spring-loaded, arc-wing baffles described above, are configured to seal the pass-through system (905) along the sides/ends of the system, while also channeling air flow as discussed above. Also included with the pass-through system (905) is a top wall (970), a front closing door (940A), a back closing door (940B), a pair of front swinging doors (960A, 960B), and a pair of back swinging doors (961A, 961B) to provide a contained treatment zone (975) in which the pallets (925) of perishable product can be treated with functional treatments, such as, e.g., sanitizing substances, and/or cooled. For example, as shown in the embodiment of FIGS. 14A and 14B, the front closing door (940A) and the back closing door (940B) are configured to swing open and closed (or, alternatively, move up and down) as the pallets (925) of perishable product are moved into the contained treatment zone (975) via the conveyor (920). By contrast, the pair of front swinging doors (960A, 960B) and the pair of back swinging doors (961A, 961B) are configured to swing open and closed (e.g., these doors swing across the top of the conveyor (920)), as the pallets (925) of perishable product are moved into the contained treatment zone (975) via the conveyor (920). As the pallets (925) of perishable product move along the conveyor (920), and are thereafter closed or sealed within the contained treatment zone (975), by closing one or more of the front closing door (940A), the back closing door (940B), the pair of front swinging doors (960A, 960B), and the pair of back swinging doors (961A, 961B), forced air (including, e.g., cooling air) and/or suction air, as well as functional treatments, such as, e.g., sanitizing substances, are circulated or recirculated across the pallets (925) of perishable product via the axial fans (910) attached to the respective plenum (900).

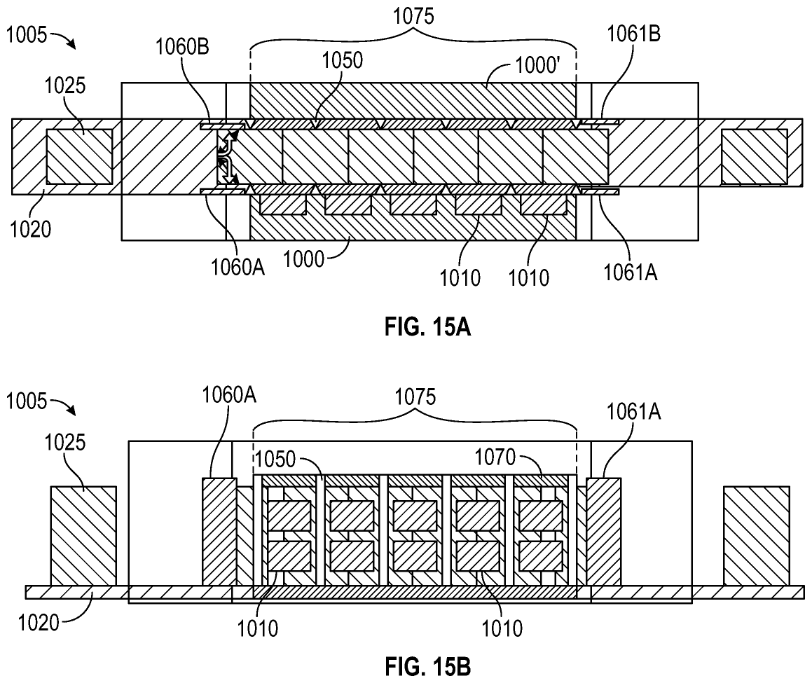

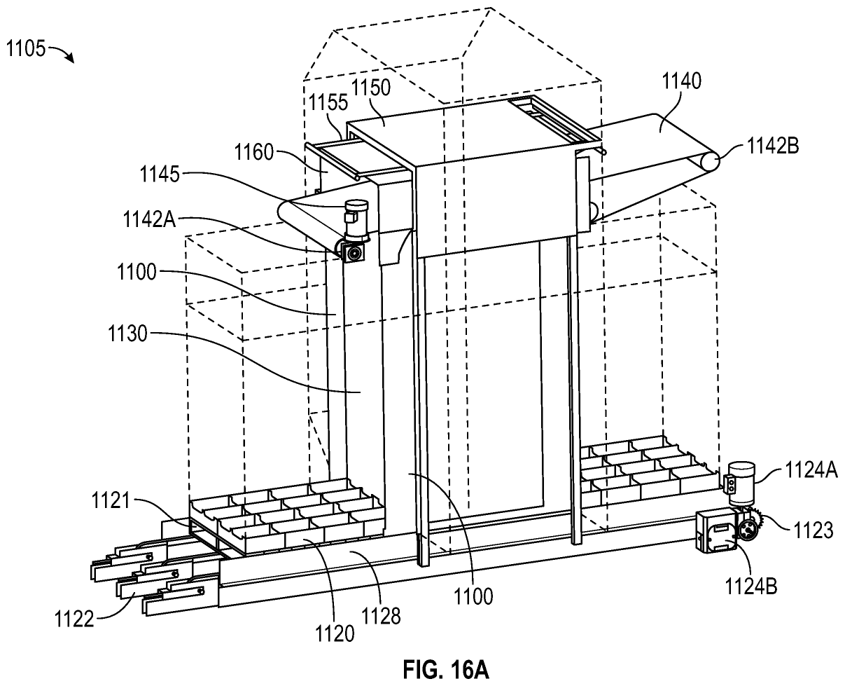

FIGS. 15A and 15B illustrate an alternative pass-through system having swing seal doors and no containment zones/modules for providing forced air (including, e.g., cooling air) to multiple pallets of perishable product according to an embodiment of the invention. As shown in FIGS. 15A and 15B, the pass-through system (1005) includes a plenum (1000) that is provided with a plurality of axial fans (1010) attached thereto. Positioned on an opposite side to the plenum (1000) is another plenum (1000′) that does not include any axial fans. The plenums (1000, 1000′) are attached to a conveyor (1020) that is positioned between the plenums (1000, 1000′). The conveyor (1020) is configured to move one or more pallets (1025) of perishable product through the pass-through system (1005). As discussed, the conveyor (1020) is configured to move the one or more pallets (1025) of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (1020) can also be configured to reverse direction so that treated pallets exit the system on the same side as they entered. The pass-through system (1005) further includes a plurality of angled pressure baffles/rollers/sweep wings (1050) (or similar devices) for channeling air flow through the perishable product included on the pallets (1025), while the pallets (1025) are moving or paused in the pass-through system (1005). The angled pressure baffles/rollers/sweep wings (1050), which can comprise the configurations for the spring-loaded, arc-wing baffles described above, are configured to seal the pass-through system (1005) along the sides/ends of the system, while also channeling air flow as discussed above. Also included with the pass-through system (1005) is a top wall (1070), a pair of front swinging doors (1060A, 1060B), and a pair of back swinging doors (1061A, 1061B) to provide a contained treatment zone (1075) in which the pallets (1025) of perishable product can be treated with functional treatments, such as, e.g., sanitizing substances, and/or cooled. For example, as shown in the embodiment of FIGS. 15A and 15B, the pair of front swinging doors (1060A, 1060B) and the pair of back swinging doors (1061A, 1061B) are configured to swing open and closed (e.g., these doors swing across the top of the conveyor (1020)), as the pallets (1025) of perishable product are moved into the contained treatment zone (1075) via the conveyor (1020). As the pallets (1025) of perishable product move along the conveyor (1020), and are thereafter closed or sealed within the contained treatment zone (1075), by closing the pair of front swinging doors (1060A, 1060B) and the pair of back swinging doors (1061A, 1061B), forced air (including, e.g., cooling air) and/or suction air, as well as functional treatments, such as, e.g., sanitizing substances, are circulated or recirculated across the pallets (1025) of perishable product via the axial fans (1010) attached to the respective plenum (1000). According to the embodiment of FIGS. 15A and 15B, a pass-through system (1005) is provided that includes swing seal doors (e.g., the pair of front swinging doors (1060A, 1060B) and the pair of back swinging doors (1061A, 1061B)) and no entry or exit containment zones/modules. According to this embodiment, no extra isolation doors or containment modules are required if treatments and/or cooling can be applied effectively, safely, and without significant loss (e.g., ionized water, hydration, etc.).

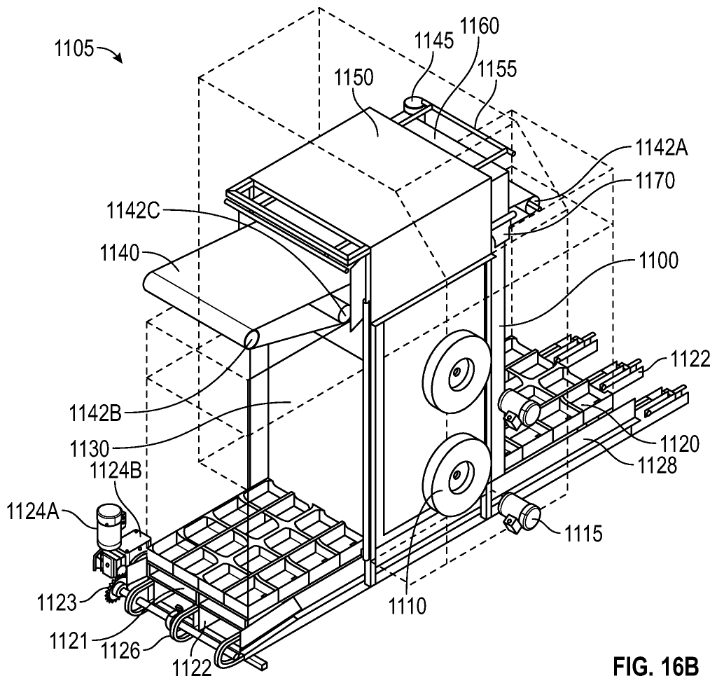

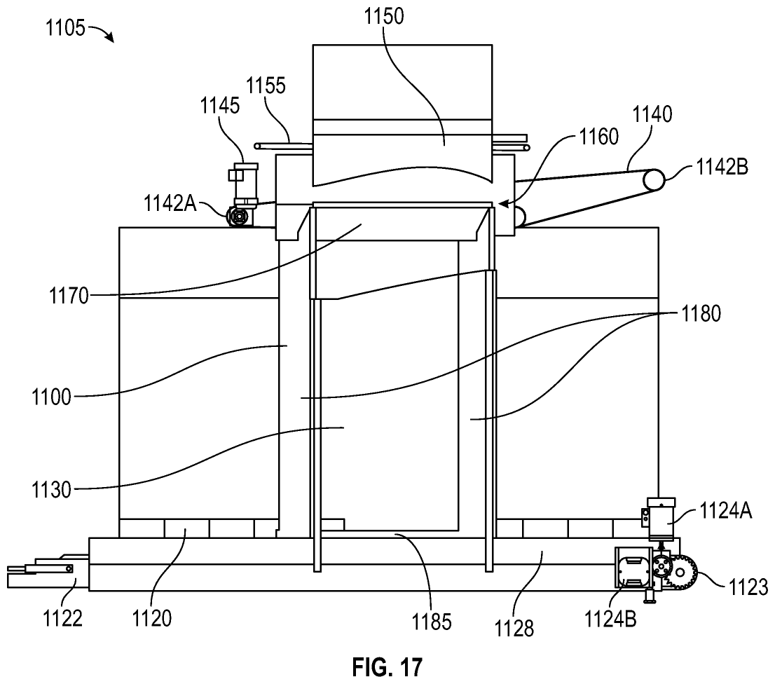

FIGS. 16A and 16B illustrate a pass-through system for providing forced air (including, e.g., cooling air) to a pallet of perishable product according to an embodiment of the invention. As shown in FIGS. 16A and 16B, a pass-through system (1105) is provided that includes a plenum (1100) having at least two axial fans (1110) attached thereto. The axial fans (1110) are configured to be powered via respective outboard motors (1115). Included with the plenum (1100), at a top end thereof, is a conveyor box (1160) (or upper sealing conveyor) having a top conveyor or belt (1140) that is configured to rotate around a first conveyor roller (1142A), a second conveyor roller (1142B), and a third conveyor roller (1142C) via a motor (1145). The conveyor box (1160) (or upper sealing conveyor) is spring hung on parallel arms or frame member (1155). The conveyor box (1160) (or upper sealing conveyor) engages with a flexible seal member (1170) that is fixed to frame member (1155) and is configured to hinge for sealing the conveyor box (1160) by providing a flexible seal against the conveyor box (1160). The conveyor box (1160), the frame member (1155), the flexible seal member (1170), and the plenum (1100) are all covered via a top cover member (1150). The pass-through system (1105) further includes a conveyor (1120) at a bottom end thereof, with the conveyor (1120) including a base member (1121), a belt member (1128), conveyor guide rails (1122), and roller members (1126). The conveyor (1120) is configured to move one or more pallets of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (1120) can also be configured to reverse direction so that treated pallets exit the system on the same side as they entered. The conveyor (1120) functions by rotating the belt member (1128) along the conveyor guide rails (1122) and roller members (1126). The roller members (1126) rotate via a gear member or chain drive (1123) that is powered by a motor (1124A) and a drive mechanism (1124B). The pass-through system (1105) provides for the transfer of one or more pallets (1130) of perishable product through a treatment area/zone/chamber in order to treat the perishable product with functional treatments, such as, e.g., sanitizing substances, and/or cool the perishable product. The pallet(s) (1130) of perishable product are moved through the pass-through system (1105) via the conveyor (1120), at a base on the pallet(s) (1130), as well as the top conveyor or belt (1140), at a top end of the pallet(s) (1130).

According to embodiments described herein, the one or more conveyors are configured to move the pallets quickly into and out of the treatment chamber (e.g., a containment treatment chamber) and hold them in place, move them at a deliberate rate through, or pause for a specified treatment dwell time within individual treatment zones of the treatment chamber or the treatment chamber (e.g., a containment treatment chamber) of the pass-through system. According to another embodiment, the one or more conveyors pause the one or more pallets (or hold the pallets in place) for (i) a treatment dwell time of seconds to a dwell time of less than 15 minutes to treat the perishable product within individual treatment zones of the treatment chamber or the treatment chamber of the pass-through system, and/or (ii) a cooling dwell time of at least one hour to cool the perishable product within individual treatment zones of the treatment chamber or the treatment chamber of the pass-through system. Within individual treatment zones or within the full treatment system(s) or chamber(s) each can be configured and programmed to deliver product specific and/or substance specific treatments with different treatment dwell times including one or more of the following, (i) a short duration treatment dwell time of less than one minute, (ii) a medium treatment dwell time of one to 15 minutes, and/or (iii) a prolonged treatment dwell time when adding one more cooling chambers of from 15 minutes to 120 minutes.

FIG. 17 illustrates a side view of the pass-through system (1105) shown in FIGS. 16A and 16B. As shown in FIG. 17, as the pallet(s) (1130) of perishable product move along the conveyor (1120) and into the treatment zone, which is covered by the top cover member (1150), the pallet(s) (1130) further engage with the top conveyor or belt (1140) provided within the conveyor box (1160) that also aids in moving the pallet(s) (1130) of perishable product through the pass-through system (1105). The conveyor box (1160), which is fixed to the frame member (1155), is configured to move up and down in order to allow for the pallet(s) (1130) of perishable product to move into the treatment zone. As the conveyor box (1160) moves up and down, the flexible seal member (1170) hinges and/or seals against the conveyor box (1160) in order to provide a top seal to the pallet(s) (1130) of perishable product moving through the pass-through system (1105). Vertical seals (1180), which are configured to hinge for sealing, are also included along the plenum (1100) to provide a vertical seal against the pallet(s) (1130) of perishable product. The vertical seals (1180) extend vertically up to and overlap with the flexible seal member (1170) to provide an overall seal against the pallet(s) (1130) of perishable product. Lower seals (1185) are also included to provide a seal along the base of the pallet(s) (1130) of perishable product.

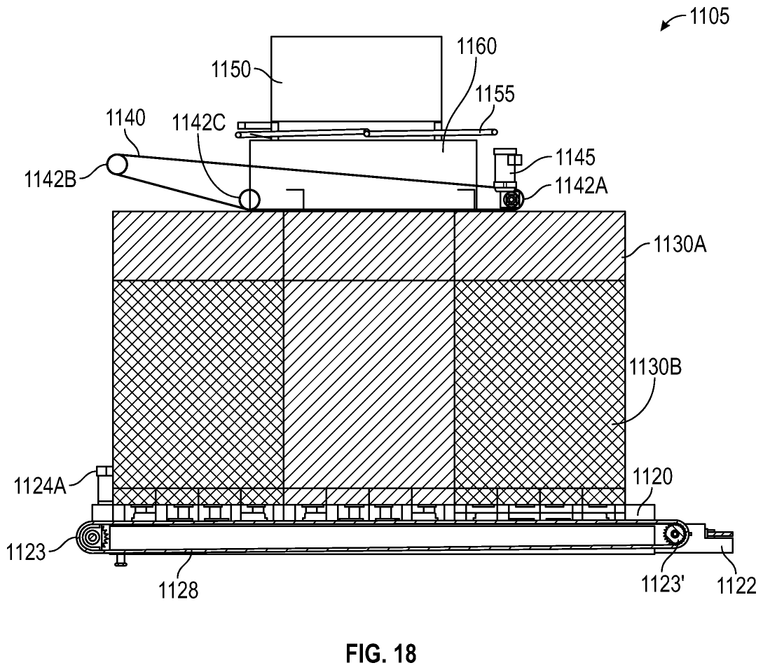

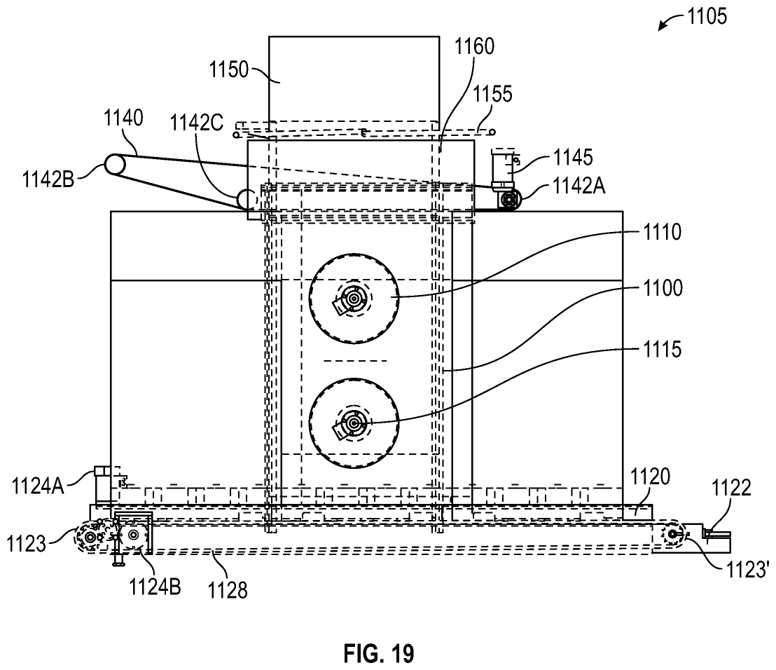

FIGS. 18 and 19 are schematic illustrations of a side view(s) of the pass-through system (1105) shown in FIGS. 16A and 16B. As shown in FIG. 18, the pass-through system (1005) is configured to allow for both tall pallets (1130A) (e.g., 87 to 88 inch pallets) of perishable product to move through the pass-through system (1105), as well short pallets (1130B) (e.g., 68 to 70 inch pallets) of perishable product to move through the pass-through system (1105). FIG. 18 further illustrates the attaching of the conveyor box (1160) (or upper sealing conveyor) to the parallel arms or frame member (1155) by being spring hung thereto.

FIG. 19 illustrates the schematics relating to the axial fans (1110) provided within the plenum (1100), which are powered by outboard motors (1115). FIG. 19 further illustrates the schematics relating to the conveyor (1120), which functions by rotating the belt member (1128) along the conveyor guide rails (1122) and roller members (not shown). The roller members (not shown) rotate via a pair of gear members or chain drive (1123, 1123′) that are powered by a motor (1124A) and a drive mechanism (1124B). FIG. 19 also illustrates the schematics relating to the top conveyor or belt (1140), which is configured to rotate around a first conveyor roller (1142A), a second conveyor roller (1142B), and a third conveyor roller (1142C) via a motor (1145).

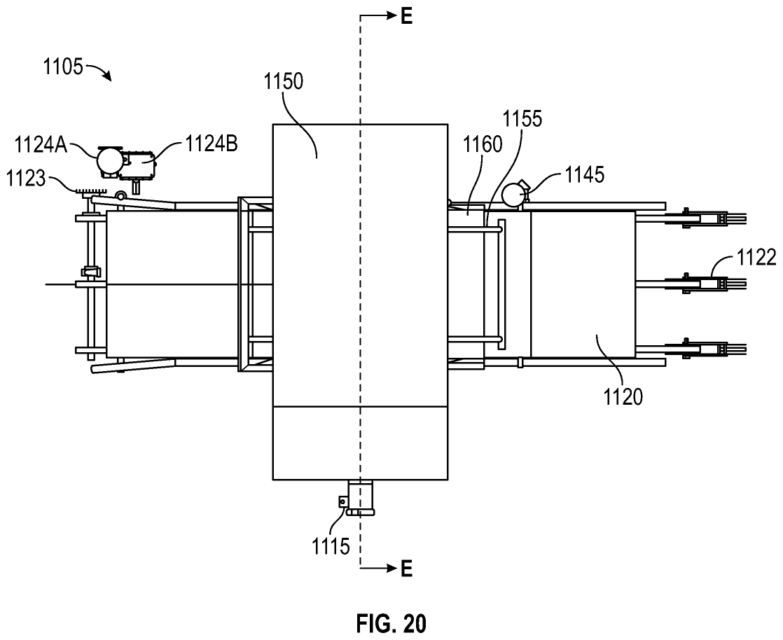

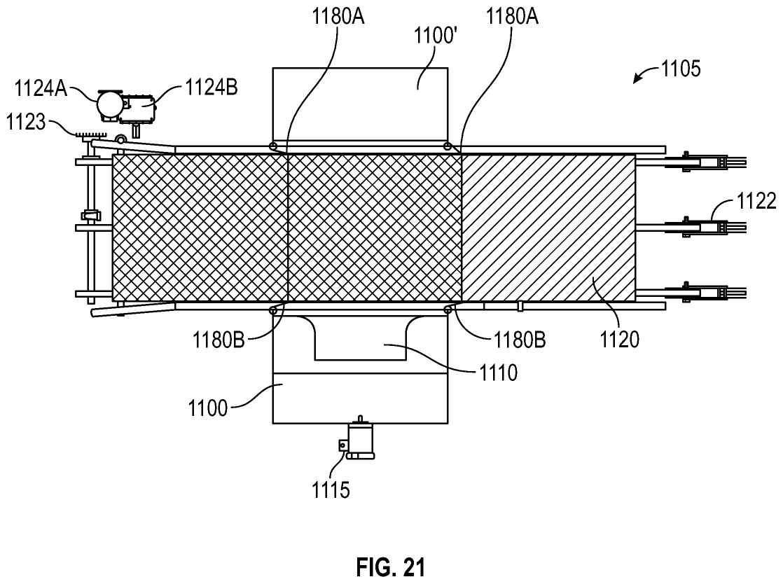

FIGS. 20 and 21 are schematic illustrations of a top view of the pass-through system (1105) shown in FIGS. 16A and 16B. As shown in FIG. 20, the top cover member (1150) is included to provide a treatment zone in which pallets of perishable product, which are transferred to the treatment zone via the conveyor (1120), can be treated with functional treatments, such as, e.g., sanitizing substances, and/or cooled. As further illustrated in FIG. 21, the pallets of perishable product can be treated and/or cooled via air flow provided by axials fans (1110) included within the plenum (1100), with the axial fans (1110) being driven by two or more outboard motors (1115). As discussed above, vertical seals (1180A, 1180B) are included, with one or more vertical seals (1180A) being provided along the pressure side of the pass-through system (1105) (i.e., the side of the system having the plenum 1100′, which does not include the axial fans (1110) and is opposite to the plenum (1100) having the axial fans (1110)). One or more vertical seals (1180B) are also included on the vacuum side of the pass-through system (1105) (i.e., the side of the system having the plenum (1100) having the axial fans (1110)). According to one embodiment, the one or more vertical seals (1180B) included on the vacuum side of the pass-through system (1105) are spring-loaded.

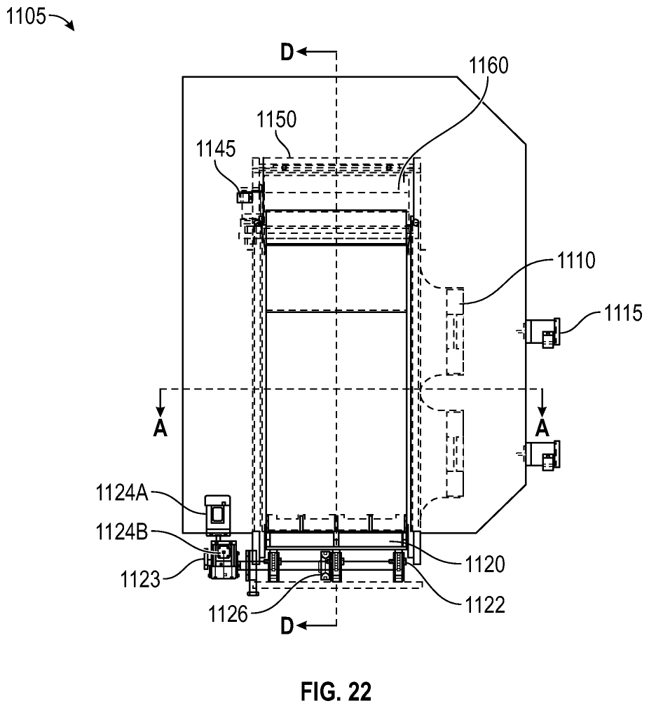

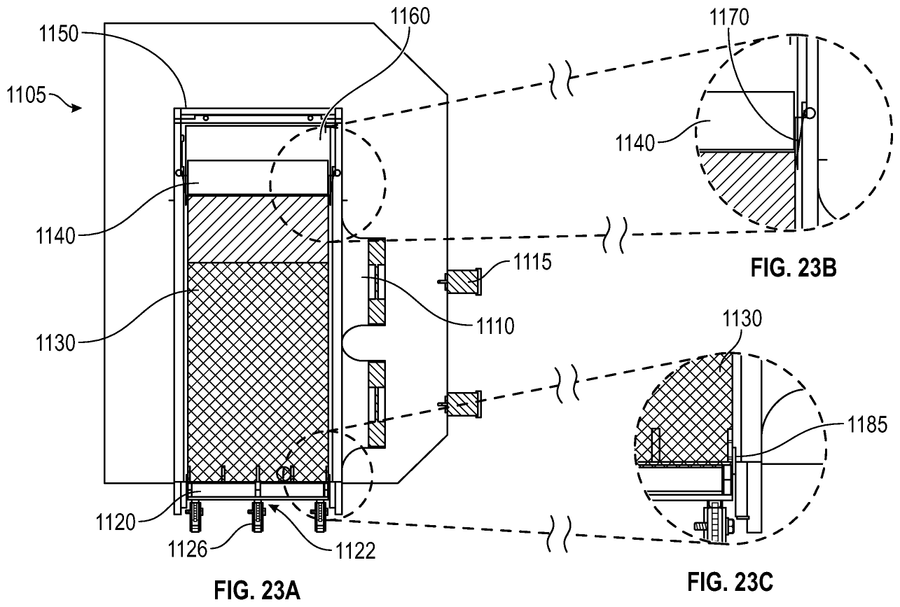

FIGS. 22 and 23A-23C are schematic illustrations of a front view of the pass-through system (1105) shown in FIGS. 16A and 16B. As shown in FIG. 22, the schematics relating to the axial fans (1110) and outboard motors (1115) are illustrated, as well as the schematics relating to the conveyor (1120) and its functionality. FIGS. 23A-23C illustrate further schematic details relating to the upper and lower sealing mechanisms. In particular, as shown in FIG. 23A and FIG. 23B, the flexible seal member (1170) is further illustrated as to how this flexible seal member (1170) hinges and/or seals against the conveyor box (1160) and/or the top conveyor or belt (1140), in order to provide a top seal to the pallet(s) (1130) of perishable product moving through the pass-through system (1105). According to one embodiment, the flexible seal member (1170) seals the conveyor box (1160) and/or the top conveyor or belt (1140), in order to isolate the portion of the top conveyor or belt (1140) that is outside the treatment zone (i.e., the area within the top cover member (1150)). FIG. 23A and FIG. 23C further illustrate details of the lower seals (1185), which are configured to isolate the lower portion of the pallets (1130) from the treatment zone (i.e., the area within the top cover member (1150)).

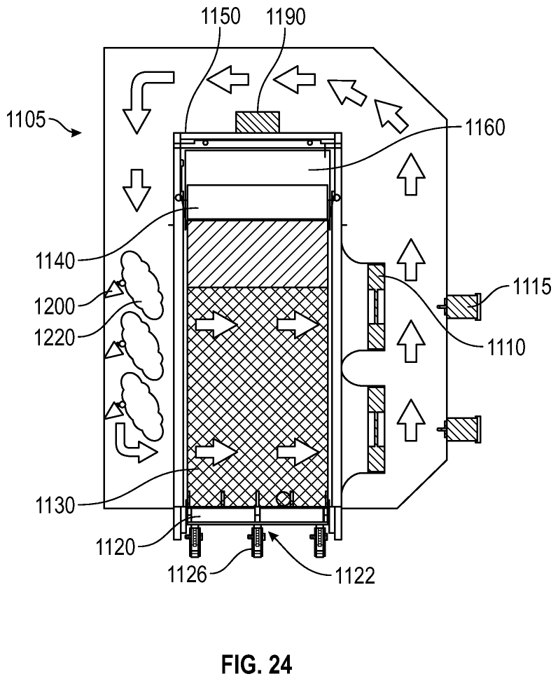

FIG. 24 is a schematic front view of a portion of the pass-through system of FIGS. 16A and 16B, in which forced air (including, e.g., cooling air) and/or functional treatments are being circulated or recirculated through the system. In particular, as shown in FIG. 24, a pallet (1130) of perishable product is positioned within the treatment zone of the pass-through system (1105). While forced air could be recirculated across the pallet (1130) of perishable product in order to cool the product using the axial fans (1110), according to the embodiment of FIG. 24, only functional (or sanitizing) treatment(s) is being conducted. To conduct the functional (or sanitizing) treatment(s), one or more treatment sprayers (1200) can be included to provide a gaseous, vaporized, and/or atomized functional substance treatment (1220) (e.g., sanitizer) to the pallet(s) (1130) of product. As further shown in FIG. 24, the axial fans (1110) allow for the gaseous, vaporized, and/or atomized functional substance treatment (1220) to be recirculated through the pallet(s) (1130) of product (see, e.g., horizontal and/or vertical arrows in FIG. 24). According to an embodiment, the gaseous, vaporized, and/or atomized functional substance treatment (1220), including, e.g., sanitizing substances, are added to the recirculating air continually, intermittently, in stages, steps, cycles, or pulses. According to an embodiment, the functional substance treatment (1220) is a first substance, while a second substance treatment (not shown) which is different than the first substance is applied to the surface of the perishable product at synchronous or asynchronous points during the treating of the perishable product using a second carrier, wherein the second substance enhances the efficacy of the first substance.

According to an embodiment, the pass-through system (1105) of FIG. 24 includes one or more sensors (1190) configured to measure the conditions within the treatment zone or chamber (or any transition zones), including the properties of any treatment substances (e.g., gaseous, vaporized, and/or atomized functional substance treatment (1220)). According to another embodiment, the pass-through system (1105) of FIG. 24 further includes a control system (not shown) configured to control the treating and/or cooling of the perishable product based on the conditions measured by the one or more sensors (1190).

According to one embodiment, when applying to the surface of perishable products functional (or sanitizing) substances that have been dispersed within the recirculating air, i.e., where the perishable products are on a pallet, the functional or substance treatment does not saturate the perishables with excess moisture (e.g., “dry-washing” or cleaning occurs).

According to one embodiment, the functional treatment comprises a substance selected from the group consisting of: a sanitizer, a preservative, an antifungal, an essential oil, a reducing agent, a surfactant, a humectant, a buffering agent, a mineral salt, alkali metal salts, an aroma, a flavoring agent, a sealing or coating substance, an anti-browning substance, an ethylene scavenger, hydrocolloid, cyclodextrins, lipids, metallic compounds, ethylene reducing compound, ethylene blocking compound, ethylene scavenging compound, a ripening agent, a nutritional substance, a probiotic, de-greening or coloring substances, nanoparticles, phages, enzymes, and a sugar substance. According to another embodiment, the functional treatment comprises a substance selected from the group consisting of: chlorine dioxide, hydrogen peroxide, ionized hydrogen peroxide, peracetic acid, ozone, ionized water, ethanol, isopropyl alcohol, ethephon, ethrel, lauryl alcohol, limonene, lemon oil, orange oil, grapefruit oil, rosemary oil, thyme oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, potassium carbonate, calcium phosphate, linear terpenes, cyclic terpenes, alcohols, aldehydes, esters, ketones, lactones, thiols, lipase, rose oil, rose essence, and fruit essence, vitamins, minerals, flavonoids, flavor compounds, color compounds, essence, essential oil, sugar, THC or THC compounds, CBD or CBD compounds, oxidizing materials, probiotics, phages, enzymes, pharmaceutical compounds, or biological compounds.

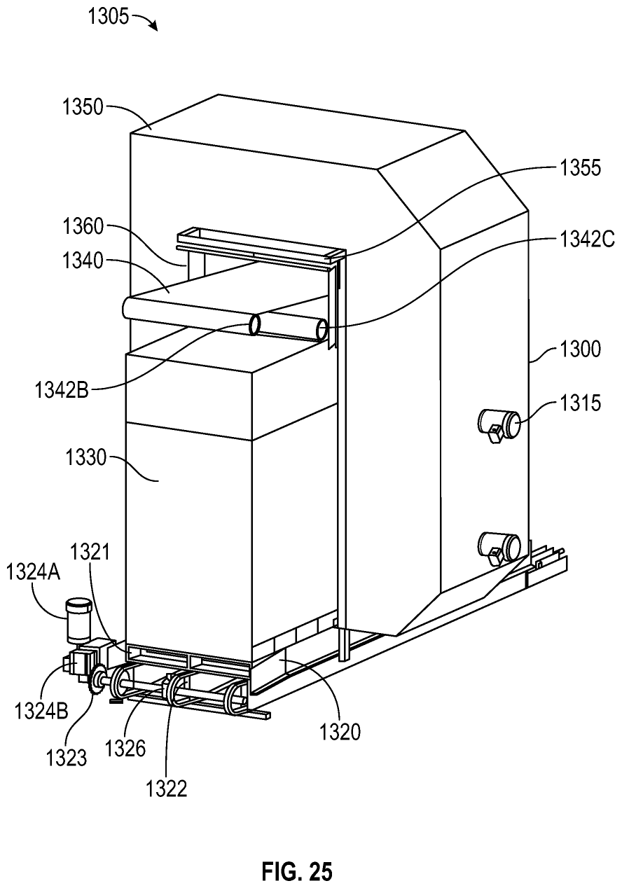

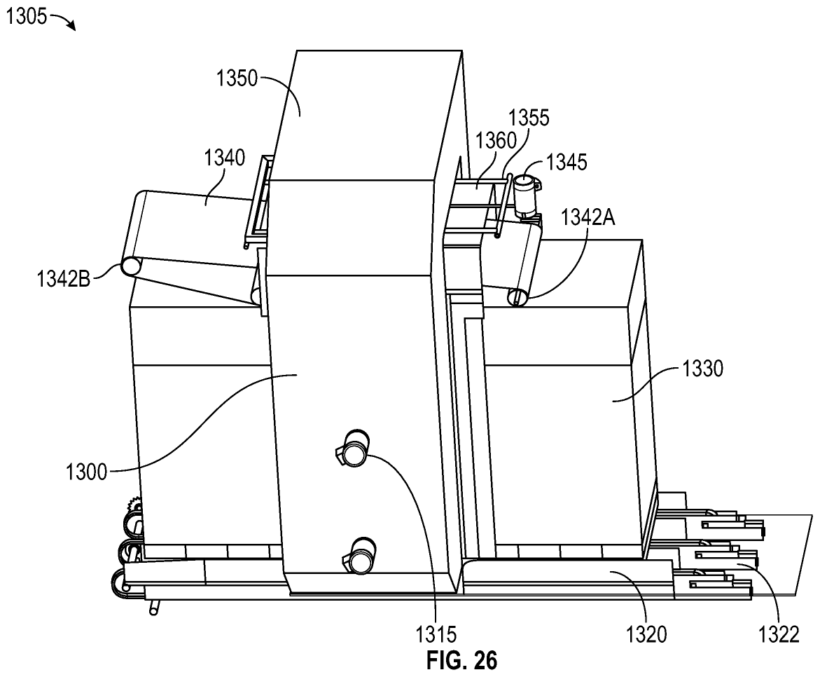

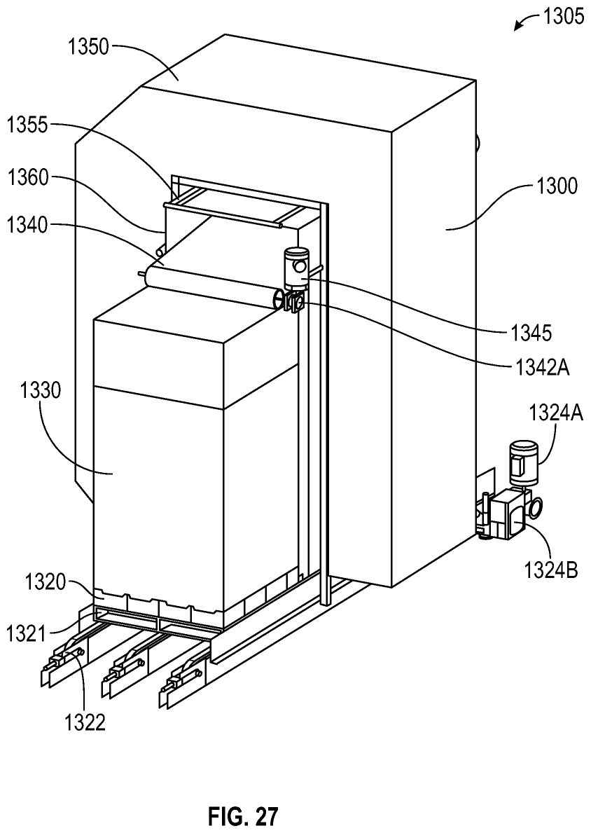

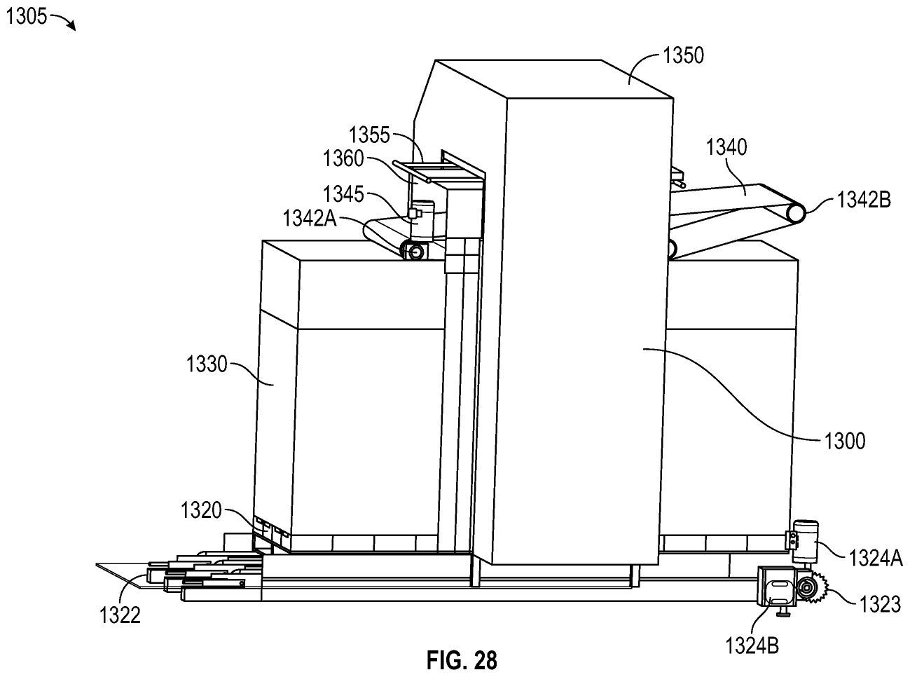

FIGS. 25-28 illustrate a pass-through system for providing forced air (including, e.g., cooling air) to a pallet of perishable product according to another embodiment of the invention. As shown in FIGS. 25-28, a pass-through system (1305) is provided that includes a plenum (1300) that can include one or more axial fans (not shown) attached thereto. The axial fans (not shown) are configured to be powered via respective outboard motors (1315). Included with the plenum (1300), at a top end thereof, is a conveyor box (1360) (or upper sealing conveyor) having a top conveyor or belt (1340) that is configured to rotate around a first conveyor roller (1342A), a second conveyor roller (1342B), and a third conveyor roller (1342C) via a motor (1345). The conveyor box (1360) (or upper sealing conveyor) is spring hung on parallel arms or frame member (1355). The conveyor box (1360), the frame member (1355), and the plenum (1300) are all covered via a top cover member (1350). The pass-through system (1305) further includes a conveyor (1320) at a bottom end thereof, with the conveyor (1320) including a base member (1321), a belt member (not shown), conveyor guide rails (1322), and roller members (1326). The conveyor (1320) is configured to move one or more pallets of perishable product quickly into and out of system, hold them in place, move them at a deliberate rate through, or pause for a specified treatment dwell time within individual treatment zones of a treatment chamber or a treatment chamber of the pass-through system, as described in further detail below. The conveyor (1320) can also be configured to reverse direction so that treated pallets exit the system on the same side as they entered. The conveyor (1320) functions by rotating a belt member (not shown) along the conveyor guide rails (1322) and roller members (1326). The roller members (1326) rotate via a gear member or chain drive (1323) that is powered by a motor (1324A) and a drive mechanism (1324B). The pass-through system (1305) provides for the transfer of one or more pallets (1330) of perishable product through a treatment area/zone/chamber/transition zone in order to treat the perishable product with functional treatments, such as, e.g., sanitizing substances, and/or cool the perishable product. The pallet(s) (1330) of perishable product are moved through the pass-through system (1305) via the conveyor (1320), at a base on the pallet(s) (1330), as well as the top conveyor or belt (1340), at a top end of the pallet(s) (1330).

According to an embodiment, the pallets of perishable product that enter the various pass-through systems described above can include a top sheet or top cap, a bottom sheet or cap, or a combination thereof, to contain and/or channel the forced air being circulated or recirculated across the pallets of perishable product via the axial fan(s). For example, as shown in FIG. 31A, a pallet of goods (1600) is provided that includes cartons (1612) for perishable products located on a pallet (1614). The pallet of goods (1600) includes a bottom sheet or cap (1616) located between the pallet (1614) and the cartons (1612). The pallet of goods (1600) includes a top sheet or cap (1618) located on a topmost row of the cartons (1612). Although cartons (1612) are illustrated as a plurality of cartons housing perishable products, other containers are contemplated.

According to an embodiment, by including the top cap (1618) and/or the bottom cap (1616), illustrated in FIG. 31A, with a pallet of perishable products, it allows for a number of significant advantages in the above-discussed pass-through systems, methods, and designs. For example, applying and securing the top cap (1618) and/or the bottom cap (1616) at the point in the process of stacking the perishable goods on a pallet eliminates the need for a separate method and device/mechanism to contain and/or channel the airflow and treatments and prevent the airflow and treatments from escaping out of the top and/or the bottom of the pallet of perishable products. Thus, according to one embodiment of the invention, a much simpler plenum and/or side-to-side channeling/containment devices (along one or both sides of the pallet) can be used. In addition, according to another embodiment, the optional use of the top cap (1618) and/or the bottom cap (1616) with the pallet of perishable products facilitates either a general shared return of airflow (e.g., recirculated treatment) over the top of all of the pallets or can provide a controlled recirculated airflow through and back over each individual pallet position through the use of, e.g., a draped tarp-like material hanging over and contacting the top edges of each pallet top cap. Alternatively, instead of using a draped tarp-like material, the above-discussed baffling material/device(s) (e.g., spring-loaded, arced-wing baffles) over the top of the pallets can be used within the pass-through system, in order to contact the edges of each pallet top cap when they are adjacent to the plenum and side baffling. In addition, according to another embodiment, by including the top cap (1618) and/or the bottom cap (1616), illustrated in FIG. 31A, with a pallet of perishable products entering the various pass-through systems described above can allow for a simple, cost effective way for individual pallets or groupings of pallets in the system to benefit from unique treatments or treatment with substance levels contained in the directed controlled airflow while it is channeled through the products on the pallet for a programmed period of time. The recirculating of the airflow (and treatments), as discussed above, can achieve efficient, low cost, product specific and programmed outcomes that improve the quality, safety, shelf-life, and value of the perishable product, while reducing waste, loss, and packaging required. For example, according to one embodiment, by including the top sheet or cap (1618) and/or the bottom sheet or cap (1616), illustrated in FIG. 31A, with a pallet of perishable products entering the various pass-through systems described above, a low cost, effective and efficient way is provided to contain and/or channel the intended airflow and treatments being recirculated through the perishable products stacked in vented trays or packages with side facing venting on the pallets. Moreover, according to one embodiment, the above-discussed top cap (1618) and/or bottom cap (1616), illustrated in FIG. 31A, are designed to be secured or tucked into the layered trays stacked on the pallets (with the caps specifically designed to match the venting pattern of the trays). The secured or tucked caps on the top and/or the bottom of the pallets, while replacing the need for more complicated and costly top or bottom containment mechanisms, work together with the side baffling/channeling devices described above, which thus directs recirculated airflow uniformly without interfering or blocking recirculated substances, treatments, and/or cooling air through the vented sides of the pallet(s) and, at the same time, preventing the recirculated airflow and any treatments from escaping out the top and/or the bottom of the stacked trays of perishable products.

According to another embodiment, FIG. 31B illustrates the pallet of goods (1610) with a wrapping film (1620) disposed around a circumference of the cartons (1612), bottom cap (1616), and top cap (1618). A sealed enclosure is formed within the boundaries of the wrapping film (1620). That is, the sealed enclosure is formed inside the wrapped film (1620), the bottom cap (1616), and the top cap (1618) such that the cartons (1612) are located within the sealed enclosure. This type of sealing of the pallet of goods (1610) with the wrapping film (1620), can allow for an effective seal of the pallet once it has been treated and/or cooled using the various pass-through systems described above.

According to an embodiment, the proposed “cap and wrap” enclosure system, described above, allows for the use of more environmentally sustainable materials in combination with the above-discussed pass-through systems for applying substance treatments, cleaning (e.g., recirculating prescribed dose and dwell time atomized for safe and effective sanitizers), and/or cooling (e.g., prior to enclosing wrapping) pallets of perishable products. Thus, the pass-through systems described above can be combined with the “cap and wrap” system to contain, preserve, protect, and enhance the shelf-life, quality, and safety of the perishable products, while reducing, and for most perishables, replacing and eliminating the need for CO₂ in MAP as a post-harvest treatment while achieving better outcome/results. Furthermore, the “cap and wrap” enclosure system can provide an improved sustainability for: 1) reducing the amount of material, 2) using more recyclable and/or recycled material, and 3) the use of reusable material (e.g., reusable caps, sleeves, wrap, etc.).

The above-discussed “cap-and-wrap” enclosure system can further be conducted in accordance with one or more of the examples disclosed in U.S. Provisional Application No. 63/472,521, which is incorporated by reference herein in its entirety.

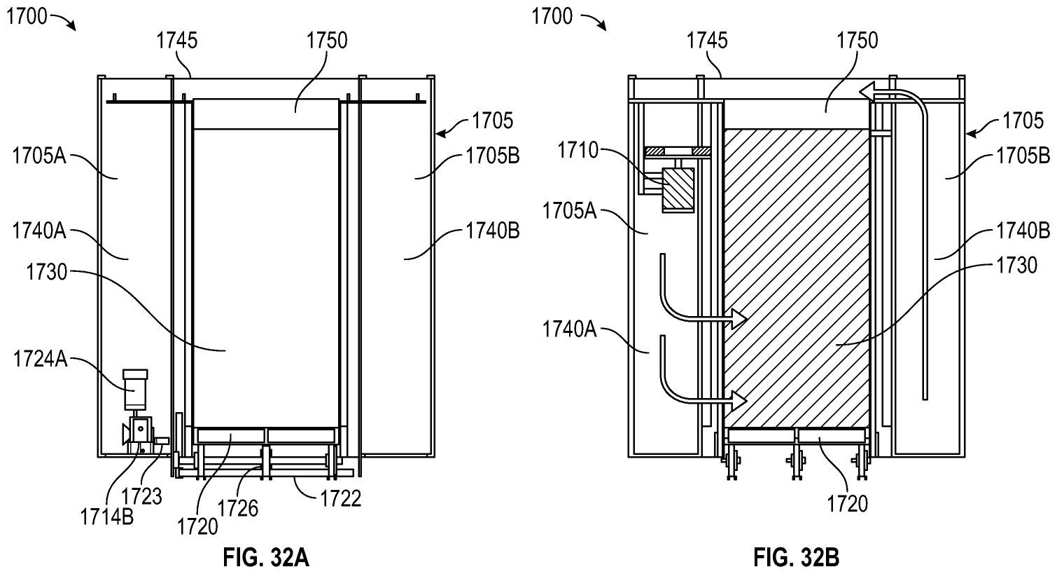

FIGS. 32A and 32B illustrate an end view and an inside view, respectively, of a single zone of a pass-through system (including, e.g., a multi-zone pass-through system) according to an embodiment of the invention. As shown in FIGS. 32A and 32B, the single zone (1700) of the pass-through system includes a plenum (1705) having a first side (1705A) with an axial fan (1710), which creates an airflow pressure side, and a second side (1705B), which is an airflow vacuum side. The single zone (1700) of the pass-through system also includes a top cover member (1750) (including, e.g., a secured top sheet or cap), a first vertical side sealing device (1740A), a second vertical side sealing device (1740B), and a horizontal top sealing device (1745). As further shown in FIGS. 32A and 32B, a pallet (1730) of perishable product is transferred to the single zone (1700) of the pass-through system (e.g., a treatment zone) via a conveyor (1720) to be treated with functional treatments, such as, e.g., sanitizing substances, and/or cooled. The conveyor (1720) functions by rotating a belt member (not shown) along conveyor guide rails (1722) and roller members (1726). The roller members (1726) rotate via a gear member or chain drive (1723) that is powered by a motor (1724A) and a drive mechanism (1724B).

As further illustrated in FIG. 32B, the pallet (1730) of perishable product can be treated and/or cooled via recirculating air flow provided by the axials fan(s) (1710) included within the first side (1705A) of the plenum (1705). In particular, as shown in FIG. 32B, a pallet (1730) of perishable product is positioned within the treatment zone (1700) of the pass-through system, while forced air flow provided by the axials fan(s) (1710) is circulated or recirculated through the pallet (1730) of perishable product and across perishable product included on the pallet (1730) (see, e.g., air flow arrows shown in FIG. 32B). As shown in FIG. 32B, forced air flow provided by the axials fan(s) (1710) is directed from the first side (1705A) or airflow pressure side of the plenum (1705) and through the pallet (1730) of perishable product, with the airflow entering the second side (1705B) or airflow vacuum side of the plenum (1705) and vertically up and across the top cover member (1750) (including, e.g., a secured top sheet or cap) of the treatment zone (1700). The forced air flow could be recirculated across the pallet (1730) of perishable product in order to cool the product using the axial fan(s) (1710), to conduct only functional (or sanitizing) treatment(s) of the perishable product, or a combination of both cooling and treating.

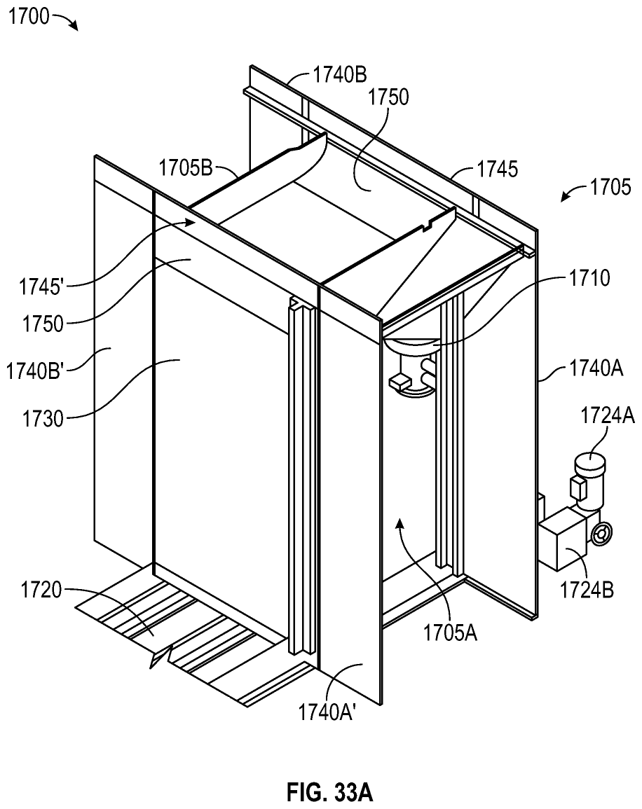

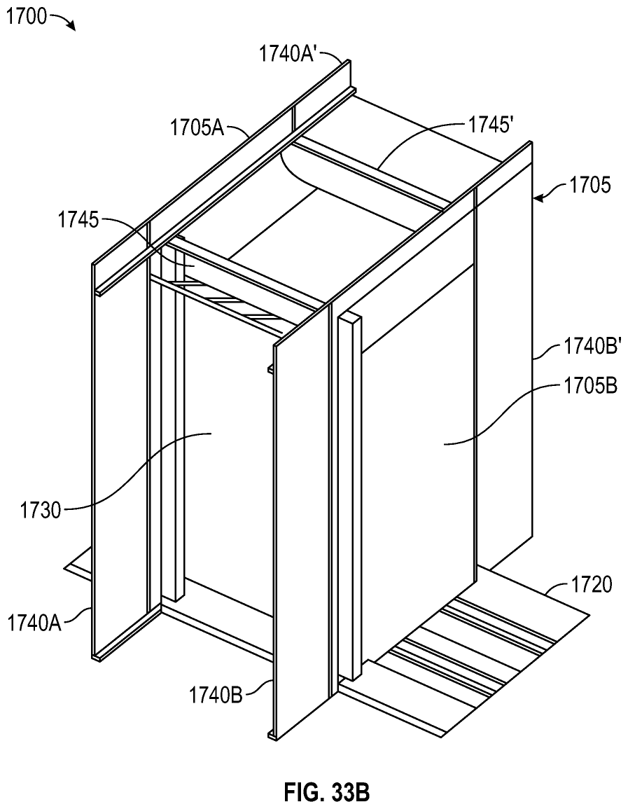

FIGS. 33A and 33B illustrate an isometric (or three-dimensional) view of the single zone (1700) of the pass-through system (e.g., a multi-zone pass-through system) shown in FIGS. 32A and 32B. As shown in FIGS. 33A and 33B, the single zone (1700) of the pass-through system includes the plenum (1705) having a first side (1705A) with an axial fan (1710), which creates an airflow pressure side, and a second side (1705B), which is an airflow vacuum side. The single zone (1700) of the pass-through system also includes a top cover member (1750) (including, e.g., a secured top sheet or cap), a first, front-side vertical side sealing device (1740A), a first, back-side vertical side sealing member (1740A′), a second, front-side vertical side sealing device (1740B), a second, back-side vertical side sealing device (1740B′), a first horizontal top sealing device (1745), and a second horizontal top sealing device (1745′). The first and second horizontal top sealing devices (1745, 1745′) can be provided along the front side and back side of the treatment zone (1700), as well as along the top sides of the first side (1705A) and second side (1705B) of the plenum (1705). As further shown in FIGS. 33A and 33B, the pallet (1730) of perishable product is transferred to the single zone (1700) of the pass-through system (e.g., a treatment zone) via the conveyor (1720) to be treated with functional treatments, such as, e.g., sanitizing substances, and/or cooled. The conveyor (1720) functions by rotating a belt member (not shown) along conveyor guide rails (not shown) and roller members (not shown). The roller members (not shown) rotate via a gear member or chain drive (not shown) that is powered by a motor (1724A) and a drive mechanism (1724B). In FIG. 33A, the isometic view is of the first side (1705A) or airflow pressure side of the plenum (1705) in which the axial fan (1710) is provided. By including the vertical and horizontal side sealing devices (1740A, 1740A′, 1740B, 1740B′, 1745 and 1745′), forced airflow, which is provided by the axial fan (1710) included with the first side (1705A) or airflow pressure side of the plenum (1705), is channeled through the pallet (1730) of perishable product and across the perishable product included on the pallet (1730) in order to treat and/or cool the perishable product. In FIG. 33B, the isometic view is of the second side (1705B) or airflow vacuum (suction) side of the plenum (1705) in which the forced airflow, which is provided by the axial fan (1710) included with the first side (1705A) or airflow pressure side of the plenum (1705), exits the pallet (1730) of perishable product (including, e.g., vented cartons of product) and is channeled up and over the top cover member (1750) (including, e.g., a top cap sealed pallet) of the treatment zone (1700), as return airflow is sucked into the axial fan (1710) for recirculation of treatments and/or cooling air.

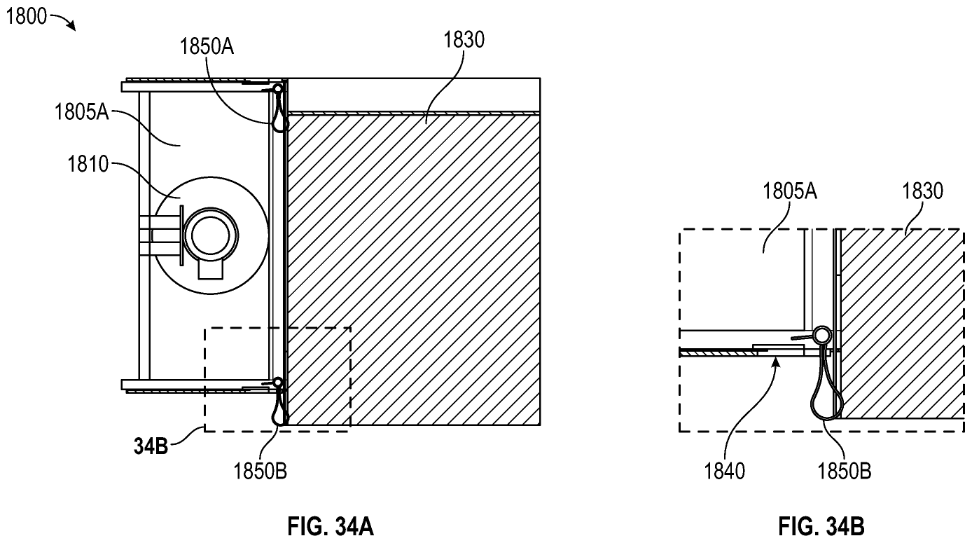

FIG. 34A is a partial, top view of a single zone of a pass-through system, which illustrates the inclusion of spring loaded loop baffles according to an embodiment of the invention. In particular, as shown in the embodiment of FIG. 34A, a single zone (1800) of a pass-through system (e.g., a multi-zone pass-through system) is provided, with the single zone (1800) having a plenum (only one side or first side (1805A), the airflow pressure side, of the plenum is shown) that includes an axial fan (1810) and a pair of vertical, spring loaded loop baffles (1850A, 1850B). As further shown in FIG. 34A, a pallet (1830) of perishable product is provided within the single zone (1800), such that the pallet (1830) of perishable product is positioned against the plenum (i.e., the first side (1805A) or airflow pressure side of the plenum) with the spring loaded loop baffles (1850A, 1850B) of the plenum providing flexible sealing and controlled airflow channeling between the plenum (i.e., the first side (1805A) or airflow pressure side of the plenum) and the pallet (1830) of perishable product when (i) the pallet (1830) of perishable product is adjacent to the plenum (i.e., the first side (1805A) or airflow pressure side of the plenum) and/or (ii) multiple pallets of perishable product pass-through the single zone (1800) without gaps between the pallets.

FIG. 34B is an exploded, partial view of the single zone (1800) of the pass-through system shown in FIG. 34A, which illustrates the pallet (1830) of perishable product positioned within the single zone (1800), such that the pallet (1830) of perishable product is positioned against the plenum (i.e., the first side (1805A) or airflow pressure side of the plenum) with the spring loaded loop baffle (1850B) of the plenum providing a spring loaded seal that pushes against the side of the material(s) of the pallet (1830) of perishable product. As further shown in the embodiment of FIG. 34B, a flexible membrane connecting sealing element (1840) is provided that is fixed to walls of the plenum (i.e., the first side (1805A) or airflow pressure side of the plenum) for providing additional sealing within the single zone (1800) and/or the plenum.

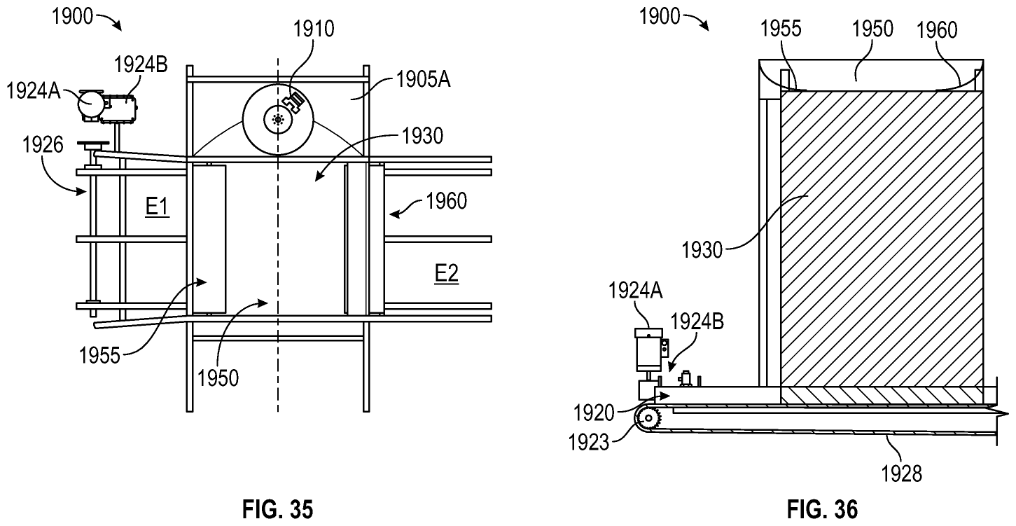

FIG. 35 is an illustration of a top view of a pallet entrance and exit of a single zone of a pass-through system (e.g., a multi-zone pass-through system) according to an embodiment of the invention. As shown in the embodiment of FIG. 35, the single zone (1900) of the pass-through system includes a plenum (only one side or first side (1905A), the airflow pressure side, of the plenum is shown) that includes an axial fan (1910) and containment/sealing devices (i.e., a pallet cap (1950) with plenum sealing and channeling devices (e.g., leading and trailing edge flap sealing materials (1955, 1960))). As further shown in the embodiment of FIG. 35, a pallet (1930) of perishable product is transferred to the single zone (1900) of the pass-through system (e.g., a treatment zone) via a conveyor (1920) to be treated with functional treatments, such as, e.g., sanitizing substances, and/or cooled. The conveyor (1920) functions by rotating a belt member (see, e.g., belt member (1923) of FIG. 36) along conveyor guide rails (not shown) and roller members (1926). The roller members (1926) rotate via a gear member or chain drive (see, e.g., gear member (1923) of FIG. 36) that is powered by a motor (1924A) and a drive mechanism (1924B). The pallet (1930) of perishable product enters the single zone (1900) of the pass-through system (e.g., a treatment zone) through an entrance (E1) via the conveyor (1920). Once the pallet (1930) of perishable product is within the single zone (1900) of the pass-through system (e.g., a treatment zone), the pallet (1930) of perishable product is sealed via the pallet cap (1950) and the plenum sealing and channeling devices (e.g., leading and trailing edge flap sealing materials (1955, 1960)), which thereby provides a sealed environment for treating and/or cooling the perishable product. After the treating and/or cooling of the perishable product, the pallet (1930) of perishable product exits the single zone (1900) of the pass-through system (e.g., a treatment zone) through an exit (E2) of the single zone (1900) via the conveyor (1920).

FIG. 36 illustrates a partial, side view of a bottom of the single zone (1900) of the pass-through system shown in FIG. 35. As shown in the embodiment of FIG. 36, leading and trailing edge flap sealing materials (1955, 1960) are provided, with the leading edge flap sealing material (1955) being provided near the entrance (see, e.g., entrance (E1) of FIG. 35) of the single zone (1900) of the pass-through system and the trailing edge flap sealing material (1960) being provided near the exit (see, e.g., exit (E2) of FIG. 35) of the single zone (1900) of the pass-through system. The leading and trailing edge flap sealing materials (1955, 1960) contact the top cap or pallet cap (1950) of the pallet (1930) of perishable product in order to seal the single zone (1900) of the pass-through system, while also channeling forced airflow provided via an axial fan (see, e.g., axial fan (1910) of FIG. 35) through the pallet (1930) of perishable product and across the perishable product contained on the pallet (1930). FIG. 36 further illustrates the conveyor (1920), which positions the pallet (1930) of perishable product adjacent to the plenum (see, e.g., first side (1905A) or airflow pressure side of the plenum of FIG. 35) in order for the pallet (1930) of perishable product to be treated with functional treatments, such as, e.g., sanitizing substances, and/or cooled. The conveyor (1920) functions by rotating a belt member (1923) along conveyor guide rails (not shown) and roller members (see, e.g., roller members (1926) of FIG. 35). The roller members (see, e.g., roller members (1926) of FIG. 35) rotate via a gear member or chain drive (1923) that is powered by a motor (1924A) and a drive mechanism (1924B).

According to the embodiments illustrated in FIGS. 32A, 32B, 33A, 33B, 34A, 34B, 35 and 36, a single zone of a pass-through system (e.g., a multi-zone pass-through system) can be provided that includes at least one axial fan and a plenum with interconnected sealing and channeling mechanisms (or devices) that direct recirculating airflow for delivery of treatments and/or cooling air through and across a pallet(s) of perishable product, which may comprise perishable product, such as, e.g., produce, in vented cartons stacked on the pallet(s). According to embodiments described above, the plenum can include vertical side sealing and horizonal top and bottom sealing devices, which can be attached with either flexible and/or fixed connections. According to embodiments described above, the return airflow channeling and/or containment/sealing devices and connections for each individual zone or for multiple zones in a pass-through system (or treatment chamber) may be made of corrosion resistant materials that are rigid, coated, flexible, semi-rigid, and/or combination thereof.

According to embodiments described herein, various systems and methods can be combined that can include the use of a pallet top sheet or top cap seal, which intersects with sealing flaps (e.g., draped heavy material) extending from a treatment chamber ceiling, to contact points on leading and trailing edges of a pallet of perishable product in order to provide a simple effect recycled air treatment zone when a pallet of perishable product is adjacent to a plenum of the treatment zone or chamber. According to embodiments described herein, individual treatment zones or modules can be replicated as part of a scalable overall system as needed for treating and/or cooling.

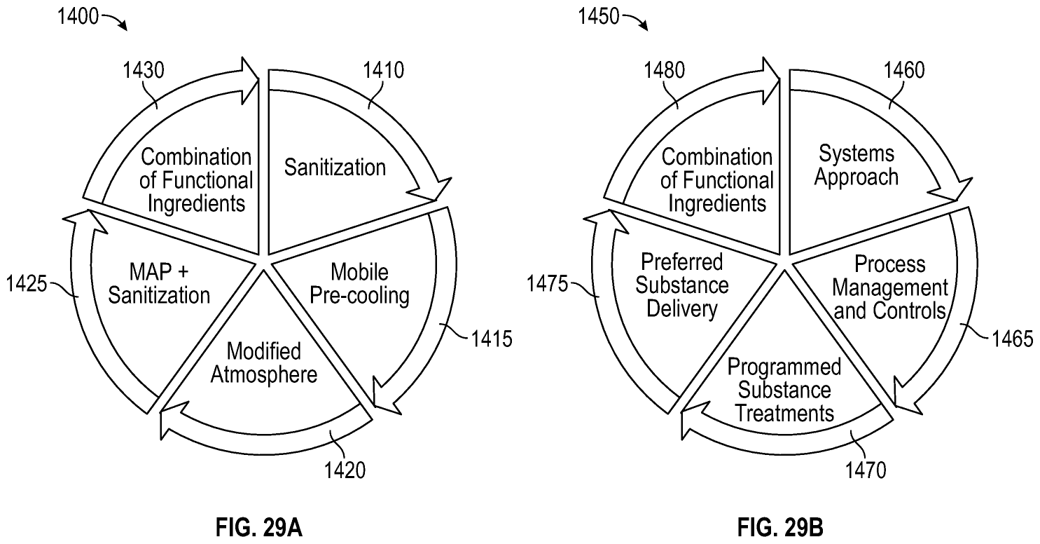

FIGS. 29A and 29B illustrate the various functional operations and systems for performing the cooling, sanitization, and/or functional treatment steps according to an embodiment of the invention. As shown in FIG. 29A, according to one embodiment, the overall system (1400) can include a plurality of independent and integrated steps, operations, and/or processes. For example, as shown in the embodiment of FIG. 29A, the overall system (1400) includes a sanitization process or step (1410), a mobile pre-cooling process or step (1415), an independent, modified atmosphere (MAP) process or step (1420), an integrated MAP and sanitization process or step (1425), and a combination of functional ingredients process or step (1430). Each of the operations, steps, or processes (1410, 1415, 1420, 1425, 1430) of the overall system (1400) of FIG. 29A can be included or not included depending upon operation desired and/or the type of perishable product being harvested and/or packaged.

FIG. 29B illustrates another embodiment of an overall system (1450) that includes a plurality of independent and integrated steps, operations, and/or processes to perform the cooling, sanitization, and/or functional treatment steps of the invention. For example, as shown in the embodiment of FIG. 29B, the overall system (1450) includes a systems approach (1460), process management and controls (1465), programmed substance treatments (1470), preferred substance delivery (1475), and a combination of functional ingredients (1480). Each of the operations, steps, or processes (1460, 1465, 1470, 1475, 1480) of the overall system (1450) of FIG. 29B can be included or not included depending upon operation desired and/or the type of perishable product being harvested and/or packaged. For example, according to an embodiment, the overall system and operational programing can be adjusted to: (i) deliver prescribed product treatment and/or cooling; (ii) accommodate different palletized products and pallet dimensions; (iii) match preferred workflow requirements, steps, and sequencing; (iv) start and stop to meet variable production timing and volumes; (v) deliver optimal and directional airflow for fast, low cost, effective treatments and cooling; (vi) efficiently reach target core cooling temperature across the entire pallet or product; and/or (vii) provide isolation-containment and/or deactivation of treatments as appropriate.

According to another embodiment, treatment modules and methods can be combined with other treatment modules in parallel or in sequence to enable multi-functional treatments. According to an embodiment, the treatment modules include a cooling module and a treatment module. According to another embodiment, the treatment modules are configured to treat the perishable products (i) before the perishable products are cooled, (ii) while the perishable products are being cooled, or (iii) after the perishable products are cooled.

According to embodiments described herein, pass-through systems and processes are provided that can be adapted and/or used for different durations of substance treatments, e.g., a fast treatment (e.g., seconds to multiple minutes) and/or a medium/slow treatment (e.g., many minutes to hours) and/or a longer duration (e.g., greater than or equal to about 1 or more hours) cooling process. For example, a long duration cooling process can be provided which requires one or more pallets of perishable product to remain paused and/or stationary during the cooling process. Thus, according to an embodiment, a cooling process cannot be accomplished as a continuous pass-through process like the short duration treatment process can be accomplished.

According to embodiments described herein, a quick treatment process can occur where one or more pallets of perishable product are treated as they (i) move continuously through one or more treatment zones in a treatment chamber or (ii) pause briefly adjacent to one or more plenum zones that is delivering the treatment, and thereafter, the one or more pallets of perishable product move on through other zones in the system and exit the treatment chamber. For example, according to one embodiment, a quick/short duration treatment process can occur within seconds or a few minutes. Thus, the treatment processes described herein can achieve a speed of treatment that is necessary to match up with or be better than current operational requirements. According to embodiments described herein, a quick treatment process with a more efficient and effective shortened treatment contact (dwell) time has a lot of unique benefits not currently delivered by any current systems, including, e.g., the lower time required for effective treatments, as well as the reducing of capital and operating costs required to deliver useful postharvest treatments to perishable product.

According to embodiments described herein, cooling can also be provided to one or more pallets of perishable product in a treatment chamber. Such a cooling process is generally a different process because the cooling can take one or more hours of constant cooling air and dwell time to reduce the perishable product(s) core temperature to a prescribed level. Thus, according to embodiments described herein, movable modular, pass-through systems are provided that allow for both a longer cooling process and/or both a shorter and longer treatment process. Moreover, as discussed above, the quick process for treating perishable product can impart treatment substances that provide both immediate and enduring benefits.

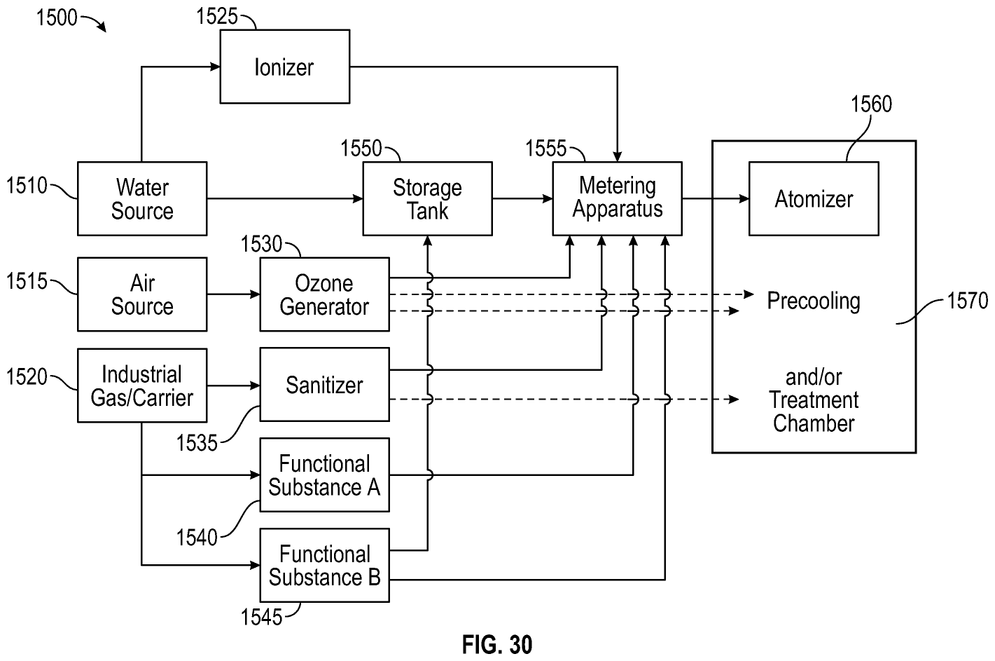

FIG. 30 illustrates an embodiment of a system having a functional treatment and delivery platform for providing functional treatment substances (such as, e.g.,. sanitization) to a perishable product after harvesting. As shown in the embodiment of FIG. 30, the system (1500) includes a water source (1510), an air source (1515), and an industrial gas or carrier source (1520). The industrial gas or carrier source (1520) can be provided to one or more of a sanitizer (1535), a functional substance A (1540), and a functional substance B (1545). According to one embodiment, the water source (1510) is provided to a storage tank (1550) in which the functional substance B (1545) is also provided. From the storage tank (1550), the combined functional substance B (1545) with the water source (1510) is provided to a metering apparatus (1555). According to another embodiment, the water source (1510) is provided to an ionizer (1525). From the ionizer (1525), acidified, neutral, and/or alkaline water and/or substances are thereafter provided to the metering apparatus (1555). According to an embodiment, the air source (1515) is provided to an ozone generator (1530), which is thereafter provided to the metering apparatus (1555). According to an embodiment, one or more of the sanitizer (1535), the functional substance A (1540), and/or the functional substance B (1545) are provided directly to the metering apparatus (1555). Each of the substances and/or carriers that are provided to the metering apparatus (1555) are thereafter provided to an atomizer (1560), which is located within a precooling, sanitization and/or treatment chamber or container (1570). The atomizer (1560) can thus deliver the various sanitizers and/or functional treatment substances to a perishable product contained within the precooling, sanitization and/or treatment chamber or container (1570). According to another embodiment, the air source (1515) which is provided to an ozone generator (1530) can be directly fed into the precooling, sanitization and/or treatment chamber or container (1570). According to another embodiment, the sanitizer (1535) can be directly fed into the precooling, sanitization and/or treatment chamber or container (1570). According to an embodiment, other optional treatments can be provided, including, e.g., dry substance treatments (e.g., smoke-like microparticles with no moisture), fog treatments (e.g., ultra-small particles with little to no moisture), and/or cold fog treatments (e.g., small particles with low moisture).

According to one embodiment, the providing of sanitization and/or functional treatment substances to a perishable product after harvesting can be conducted in accordance with one or more of the examples disclosed in PCT International Application Publication No. WO 2021/055818, U.S. Patent Application Publication No. 2020/0281233, and PCT International Application Publication No. WO 2020/181228, each of which are incorporated by reference herein in their entireties.

According to one embodiment, the various pass-through systems described herein can be combined or provided within a mobile container or a semi-trailer, as well as other types of mobile or movable containers and/or units, including pre-fabricated components, containers, and/or units or pre-fabricated modules, for postharvest processing as disclosed in PCT International Application Publication No. PCT/US2022/031364, PCT International Application Publication No. PCT/US2021/030178 (published as WO 2021/222753), U.S. patent application Ser. No. 17/610,402, and U.S. patent application Ser. No. 17/826,048 (published as US 2022/0279821), each of which are incorporated by reference herein in their entireties.

The embodiments of the invention described herein include the use of the terms “contain,” “contained,” or “containment.” According to the various embodiments described herein, these terms can mean, for example, (i) containment on one or more sides of the palletized product, (ii) containment below the palletized product, (iii) containment above the palletize product, (iv) containment of the palletized product within a closed treatment chamber, and/or (v) a treatment chamber or module containing the palletized product with one or more adjoining containment-treatment isolation chambers/module.

The embodiments of the invention described herein include perishable products that are able to be treated and/or cooled by the pass-through system of the invention. For example, perishable products include, but are not limited to, lettuce products, berries, bananas, avocado, basil, broccoli, beans, cucumbers, eggplants, squash and other herbs and vegetables, tomatoes, berries, cherries, grapes, peaches, melons and other fruit, or highly perishable produce. According to embodiments, the perishable product is cannabis and hemp or medicinal products. According to embodiments, the perishable product is a floral product including roses and cut flowers.

Although the embodiments of the invention described herein disclose the treating and/or cooling of pallets of product and/or palletized product, the inventive systems and methods described herein can further be used with bins of product or other “bulk packaging,” such as, e.g., bulk sleeves, burlap bags, or totes stacked on slip sheets, and/or other types of bulk product packaging. According to one embodiment, the inventive systems and methods described herein can be used with various product packaging types, as long as the product packaging types (e.g., pallets, bins, and/or bulk packaging) allow for the conveyance, containment, and directed airflow through and/or across the product in a manner that allows for the treatment(s) and/or cooling. According to another embodiment, the perishable product is within containers having vents on one or more sides in order for the perishable product to be treated with the substance treatment provided by the at least one treatment delivery mechanism, by allowing airflow to contact the perishable product. According to another embodiment, the perishable product is within containers having two or more vents and/or an uncovered open top in order for the perishable product to be treated with the substance treatment provided by the at least one treatment delivery mechanism, by allowing airflow to contact the perishable product. Moreover, according to an embodiment, the perishable product is within packaging having ventilation characteristics that allow for pass-through airflow and contact with the perishable product for treatment.

According to an embodiment of the invention, protective coatings and other materials can be applied to the walls of the pass-through system, conveyor system, and/or any other materials that will come into contact with the sanitizing ingredients.

Another embodiment of the invention relates to using unconventional materials to treat and/or cool the perishable product. For treatment, solutions of materials that include organic liquids such as alcohols have excellent sanitizing properties. The electrical system for the pass-through system could require specifications for flammable components or modified atmosphere. Additionally, industrial gas such as nitrogen could be used to provide an inert atmosphere inside the system and also be a component to aid the cooling process.

The various embodiments of the invention described herein allow for treating and/or cooling various perishable products designed to accomplish the treatment and/or cooling in an efficient manner while assuring the benefits of better, safer, longer lasting product. This includes longer shelf-life (lower respiration), less spoilage/decay, less dehydration, timely treatments, and packaging for control of condition, quality, organoleptic characteristics, and ripening.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

Although the foregoing description is directed to the preferred embodiments of the invention, it is noted that other variations and modifications will be apparent to those skilled in the art and may be made without departing from the spirit or scope of the invention. Moreover, features described in connection with one embodiment of the invention may be used in conjunction with other embodiments, even if not explicitly stated above.

1. A mobile, modular pass-through system for treating and/or cooling a perishable product to its intended condition, the system comprising:
(a) at least one plenum;
(b) at least one axial fan attached to the at least one plenum, the at least one axial fan configured to recirculate forced air through one or more pallets of perishable product and across perishable products contained on the one or more pallets of perishable product;
(c) one or more sealing mechanisms configured to contain and channel the forced air being recirculated between the at least one plenum and through the one or more pallets of perishable product and across the perishable products contained on the one or more pallets of perishable product;
(d) at least one treatment delivery mechanism;
(e) one or more conveyors configured to move the one or more pallets of perishable product through the pass-through system; and
(f) a treatment chamber configured to provide a sealed environment for treating and/or cooling the perishable product.

2. The system according to claim 1, wherein the one or more sealing mechanisms comprise (i) at least one vertical sealing device and (ii) at least one horizontal sealing device.

3. The system according to claim 2, wherein the one or more sealing mechanism comprise (i) two vertical sealing devices and (ii) two horizontal sealing devices.

4. The system according to claim 1, wherein the forced air is cooled.

5. The system according to claim 1, wherein the one or more pallets of perishable product includes at least one of (i) a secured top sheet or top cap, (ii) a bottom sheet or cap, or (iii) a combination of (i) and (ii), to contain and/or channel the forced air being recirculated through the one or more pallets of perishable product and across the perishable products contained on the one or more pallets of perishable product via the at least one axial fan.

6. The system according to claim 1, wherein the at least one treatment delivery mechanism is configured to provide a small micron, gaseous, vaporized, and/or atomized functional substance treatment to the perishable product contained on the one or more pallets of perishable product via recirculated air.

7. The system according to claim 6, wherein the substance treatment does not saturate the perishable product with excess moisture.

8. The system according to claim 6, wherein the perishable product is within containers having two or more vents and/or an uncovered open top in order for the perishable product to be treated with the substance treatment provided by the at least one treatment delivery mechanism, by allowing airflow to contact the perishable product.

9. The system according to claim 1, wherein the at least one treatment delivery mechanism is configured to provide substance treatments that include one or more of hydration, sanitizing, conditioning, neutralization of fungicide/pesticide/herbicide chemicals on a surface of the perishable product, and other protective, preservative, and functional substances or treatments.

10. The system according to claim 9, wherein the substance treatments include one or more of (i) sanitizers/oxidizers such as ozone, hydrogen peroxide, ionized hydrogen peroxide, peracetic acid, ionized water, acidified water, alkaline water, sulfur dioxide, chlorine compounds and derivatives, (ii) ethylene, (iii) 1-MCP, (iv) water/humidity, or (v) combinations thereof.

11. The system according to claim 9, wherein the substance treatments are (i) selected from the group consisting of a sanitizer, an antifungal, an essential oil, a reducing agent, a surfactant, a humectant, a photosensitizer, a buffering agent, a mineral salt, an aroma, a sweetener or flavoring agent, a sealing or coating substance, an anti-browning substance, an ethylene scavenger, ethylene blocking compound, a ripening agent, a nutritional substance, a probiotic, a coloring, nano particles, phages, enzymes, sugar substance, an absorbent, a neutralizing agent, and an oxidizing agent, or (ii) selected from the group consisting of chlorine dioxide, hydrogen peroxide, peracetic acid, ozone, ionized water, ethephon, ethrel, and lauryl alcohol, lemon oil, orange oil, grapefruit oil, rosemary oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, calcium phosphate, esters, linear terpenes, cyclic terpenes, alcohols, aldehydes, esters, ketones, lactones, thiols, rose oil, rose essence, air, and fruit essence.

12. The system according to claim 1, wherein the treatment chamber is configured to treat the perishable product (i) before the perishable product is cooled, (ii) while the perishable product is being cooled, or (iii) after the perishable product is cooled.

13. The system according to claim 1, wherein the treatment chamber is configured to treat the perishable product without applying heat.

14. The system according to claim 1, wherein the perishable product includes one or more of (i) pre-packed product after harvesting, (ii) bulk packed product into a harvest container to supply to a packing line, and (iii) product packed into a partial container that needs additional handling/processing steps to complete packing of harvested product.

15. The system according to claim 1, wherein the one or more conveyors are configured to move the one or more pallets quickly into and out of the treatment chamber and hold them in place, move them at a deliberate rate through, or pause for a specified treatment dwell time within individual treatment zones of the treatment chamber or the treatment chamber of the pass-through system.

16. The system according to claim 15, wherein each of the individual treatment zones within the treatment chamber or the treatment chamber is configured and programmed to deliver a product specific treatment and/or a defined substance treatment with a defined dwell time, wherein the one or more conveyors pause the one or more pallets to achieve the product specific treatment and/or the defined substance treatment for the defined dwell time within the individual treatment zones within the treatment chamber or the entire treatment chamber of the pass-through system.

17. The system according to claim 1, wherein the one or more conveyors are configured to move the one or more pallets into and out of the treatment chamber and hold the one or more pallets in place for a specified treatment dwell time within individual treatment zones of the treatment chamber or the treatment chamber of the pass-through system, wherein the one or more conveyors reverse direction so treated pallets exit the treatment chamber.

18. The system according to claim 17, wherein the one or more conveyors hold the one or more pallets in place for (i) a short duration treatment dwell time of less than one minute to treat the perishable product within individual treatment zones of the treatment chamber or the treatment chamber of the pass-through system, (ii) a medium duration treatment dwell time of one minute to 15 minutes to treat the perishable product within individual treatment zones of the treatment chamber or the treatment chamber of the pass-through system, and/or (iii) a prolonged duration treatment dwell time when adding one or more cooling chambers of from 15 minutes to 120 minutes to treat the perishable product within individual treatment zones of the treatment chamber or the treatment chamber of the pass-through system.

19. The system according to claim 1, wherein the one or more sealing mechanisms engage with the one or more pallets of perishable product to create a seal around contact points on the one or more pallets and the at least one plenum for channeling the forced air being recirculated through the one or more pallets of perishable product and across the perishable products contained on the one or more pallets of perishable product during treatment.

20. The system according to claim 19, wherein the one or more sealing mechanisms include at least one of pressure rollers, arc loop baffles, wing baffles, angled baffles, belts, louvers, shutters, ducting, plastic, fabric, or metal guides, or similar devices for channeling and containing air flow.

21. The system according to claim 19, wherein the one or more sealing mechanisms include combinations of air dependent, spring-loaded, and other devices that are mechanically controlled and activated.

22. The system according to claim 1, wherein the pass-through system has transition zones that are present just before and just after treatment zones of the treatment chamber where pallets can collect and stage before entry and after exit to provide containment of any treatment substances from exiting the pass-through system.

23. The system according to claim 22, wherein the transition zones use one or more of rollup, side swing, or sliding doors to quickly open and close for pallet movement and substance containment.

24. The system according to claim 1, wherein the pass-through system comprises a modified shipping container, a semi-trailer, a prefabricated room, or one or more fabricated chambers/modules.

25. The system according to claim 1, further comprising one or more sensors configured to measure conditions within the treatment chamber, including the properties of any treatment substances.

26. The system according to claim 25, further comprising a control system configured to control the treating and/or cooling of the perishable product based on the conditions measured by the one or more sensors.

27. The system according to claim 1, wherein the perishable product includes one or more types of perishable product in the one or more pallets of perishable product.

28. The system according to claim 27, further comprising one or more sensors configured to identify the one or more types of perishable product in the one or more pallets of perishable product to thereby control the treating and/or cooling of the perishable product.

29. The system according to claim 28, further comprising a control system configured to control the treating and/or cooling of the perishable product based on the one or more types of perishable product identified by the one or more sensors.

30. The system according to claim 29, wherein the control system is configured to control the treating and/or cooling of the perishable product based on machine learning related to treating and/or cooling of a previously-treated perishable product based on a type of the previously-treated perishable product.

31. The system according to claim 1, wherein the at least one axial fan is configured (i) to apply forced air pressure to distribute substance treatment through the one or more pallets, and (ii) to create air flow that is reversible to either force air through the one or more pallets or suck air back through it.

32. The system according to claim 31, wherein the one or more pallets of perishable product includes at least one of (i) a secured top sheet or top cap, (ii) a bottom sheet or cap, or (iii) a combination of (i) and (ii), to contain and/or channel the air flow being created by the at least one axial fan.

33. The system according to claim 1, wherein the one or more sealing mechanisms achieve a seal when the at least one axial fan operates in either a forced air or suction air flow.

34. The system according to claim 1, further comprising cooling coils and related refrigeration equipment to reduce the temperature of the perishable product.

35. The system according to claim 1, wherein the perishable product is treated with sanitizing substances that include at least one of ozone, hydrogen peroxide, ionized hydrogen peroxide, ozonated water, ionized water, peracetic acid, sodium hypochlorite, ionized chlorinated water, electrochlorinated water, oxidizing materials, and any other form(s) (including ionized and oxidized forms) of these substances.

36. The system according to claim 35, wherein the sanitizing substances are mixed with a carrier that includes one of air or water.

37. The system according to claim 1, wherein sanitizing substances are added to recirculating air continually, intermittently, in stages, steps, cycles, or pulses.

38. The system according to claim 1, wherein the perishable product includes one or more of tomatoes, berries, cherries, fresh cut flowers, cannabis products, hemp products, or other fruits and vegetables.

39. The system according to claim 1, further comprising multiple contained treatment zones in which one or more different treatments can be applied to accomplish multiple benefits and/or enhancements to the perishable product.

40. The system according to claim 1, wherein components of the system comprise specialized materials of construction that are used to protect surfaces and mechanical components from damaging effects of any oxidizers and sanitizers used.

41. The system according to claim 1, wherein the one or more sealing mechanisms permit movement of the one or more pallets during operation either by releasing if air flow is stopped or mechanical components pull material back, or rotate, roll with, or are directionally aligned with the movement of the one or more pallets while air is still flowing.

42. A method for treating and/or cooling a perishable product to its intended condition using a mobile, modular pass-through system, the method comprising:
providing a pass-through system that includes (a) at least one plenum, (b) at least one axial fan attached to the at least one plenum, the at least one axial fan configured to recirculate forced air through one or more pallets of perishable product and across perishable products contained on the one or more pallets of perishable product, (c) at least one treatment delivery mechanism, (d) one or more conveyors configured to move the one or more pallets of perishable product through the pass-through system, and (e) a treatment chamber configured provide a sealed environment for treating and/or cooling the perishable product;
moving the one or more pallets of perishable product through the pass-through system and into the treatment chamber using the one or more conveyors; and
treating or cooling the perishable product in the treatment chamber.

43. The method according to claim 42, wherein the one or more pallets of perishable product includes at least one of (i) a top sheet or top cap, (ii) a bottom sheet or cap, or (iii) a combination of (i) and (ii), to contain and/or channel the forced air being recirculated through the one or more pallets of perishable product and across the perishable products contained on the one or more pallets of perishable product via the at least one axial fan.

44. The method according to claim 42, wherein treating the perishable product in the treatment chamber comprises applying substance treatments that include one or more of hydration, sanitizing, conditioning, neutralization of fungicide/pesticide/herbicide chemicals on a surface of the perishable product, and other protective, preservative, and functional substances or treatments.

45. The method according to claim 44, wherein the substance treatments include one or more of (i) sanitizers/oxidizers such as ozone, hydrogen peroxide, ionized hydrogen peroxide, peracetic acid, ionized water, acidified water, alkaline water, sulfur dioxide, chlorine compounds and derivatives, (ii) ethylene, (iii) 1-MCP, (iv) ethephon, (v) ethrel, (vi) lauryl alcohol, (vii) water/humidity, or (viii) combinations thereof.

46. The method according to claim 42, further comprising applying and recirculating one or more of forced air, humidity, and dispersed substance treatments across the perishable product to impart minimal free moisture on a surface of the perishable product.

47. The method according to claim 42, wherein treating the perishable product in a treatment zone, a treatment module, or the treatment chamber includes cooling of the perishable product.

48. The method according to claim 47, wherein the treating of the perishable product occurs (i) before the cooling of the perishable product, (ii) during the cooling of the perishable product, or (iii) after the cooling of the perishable product.

49. The method according to claim 42, wherein treating the perishable product in the treatment chamber is conducted without applying heat.

50. The method according to claim 42, wherein treating the perishable product in the treatment chamber comprises a batch treatment, a semi-automatic batch treatment, a hybrid pass-through with programmed pause during treatments, or a pass-through with continuous treatment.

51. The method according to claim 42, wherein treating the perishable product in the treatment chamber comprises a treatment that is programmed to provide a concentration or delivery amount of active substance to a surface of the perishable product within a controlled dwell or contact time within the treatment chamber.

52. The method according to claim 44, wherein the substance treatments are (i) selected from the group consisting of a sanitizer, an antifungal, an essential oil, a reducing agent, a surfactant, a humectant, a photosensitizer, a buffering agent, a mineral salt, an aroma, a sweetener or flavoring agent, a sealing or coating substance, an anti-browning substance, an ethylene scavenger, ethylene blocking compound, a ripening agent, a nutritional substance, a probiotic, a coloring, nano particles, phages, enzymes, sugar substance, an absorbent, a neutralizing agent, and an oxidizing agent, or (ii) selected from the group consisting of chlorine dioxide, hydrogen peroxide, peracetic acid, ozone, ionized water, ethephon, ethrel, lauryl alcohol, lemon oil, orange oil, grapefruit oil, rosemary oil, sunflower oil, other fruit-derived oils, tea tree oil, cinnamon oil, eucalyptus oil, potassium oleate, sodium dodecyl sulfate (SDS), ascorbic acid, citric acid, sodium bicarbonate, calcium phosphate, esters, linear terpenes, cyclic terpenes, alcohols, aldehydes, esters, ketones, lactones, thiols, rose oil, rose essence, air, and fruit essence.

53. The method according to claim 44, wherein the substance treatments clean the perishable product, prevents moisture loss of the perishable product, slows senescence of the perishable product, is a preservative, is comprised of ionized water or ionized air, enhances color, enhances flavor, enhances aroma, enhances texture of the perishable product, acts as a pH buffer, breaks down biofilm on a surface of the perishable product, or combinations thereof.

54. The method according to claim 44, wherein the substance treatments include a first substance, and the method further comprises directly applying a second substance which is different than the first substance to the surface of the perishable product at synchronous or asynchronous points during the treating of the perishable product using a second carrier, wherein the second substance enhances efficacy of the first substance.

55. The method according to claim 42, further comprising measuring the conditions within the treatment chamber using one or more sensors to thereby measure the properties of any treatment substances.

56. The method according to claim 55, further comprising controlling the treating or cooling of the perishable product in the treatment chamber using a control system, based on the conditions measured by the one or more sensors.

57. The method according to claim 42, wherein the perishable product includes one or more types of perishable product in the one or more pallets of perishable product, and the method further comprises identifying the one or more types of perishable product in the one or more pallets of perishable product using one or more sensors to thereby control the treating or cooling of the perishable product.

58. The method according to claim 57, further comprising controlling the treating or cooling of the perishable product in the treatment chamber using a control system, based on the one or more types of perishable product identified by the one or more sensors.

59. The method according to claim 58, wherein the control system is configured to control the treating or cooling of the perishable product based on machine learning related to treating and/or cooling of a previously-treated perishable product based on a type of the previously-treated perishable product.

60. A system to treat perishable products comprising integrated apparatuses and methods to achieve and maintain post-harvest objectives of safety, freshness, condition, and low surface microbial spoilage activity efficiently and effectively.

61. The system of claim 60, wherein a programmed treatment protocol is determined for each perishable product and the apparatuses and methods execute the programmed treatment protocol in a commercial setting.

62. The system of claim 61, wherein the programmed treatment protocol is determined based on conditions measured within the system using one or more sensors.

63. The system of claim 62, wherein the programmed treatment protocol is controlled by a control system included within the system, wherein the control system is configured to control the programmed treatment protocol based on the conditions measured by the one or more sensors.

64. The system of claim 61, wherein the perishable products include one or more types of perishable products, and the programmed treatment protocol is determined based on the one or more types of perishable products identified by one or more sensors included within the system.

65. The system according to claim 64, wherein the programmed treatment protocol is controlled by a control system included within the system, wherein the control system is configured to control the programmed treatment protocol based on the one or more types of perishable products identified by the one or more sensors.

66. The system of claim 60, wherein treatment modules and methods can be combined with other treatment modules, chambers, or zones in parallel or in sequence to enable multi-functional treatments.

67. The system of claim 66, wherein the treatment chambers include a cooling zone and a treatment zone, and wherein the treatment zone is configured to treat the perishable products (i) before the perishable products are cooled, (ii) while the perishable products are being cooled, or (iii) after the perishable products are cooled.

68. The system of claim 60, wherein the system and operational programing can be adjusted to:
(i) deliver prescribed product treatment and/or cooling;
(ii) accommodate different palletized products and pallet dimensions;
(iii) match preferred workflow requirements, steps, and sequencing;
(iv) start and stop to meet variable production timing and volumes;
(v) deliver optimal and directional airflow for fast, low cost, effective treatments and cooling;
(vi) efficiently reach target core cooling temperature across the entire pallet or product; and/or
(vii) provide isolation-containment and/or deactivation of treatments as appropriate.
